(19) United States
(12) Patent Application Publication
(10) Pub. No.: US 2026/0169253 A1
(43) Pub. Date: Jun. 18, 2026

(54) LENS BARREL

(71) Applicant: Panasonic Intellectual Property Management Co., Ltd., Osaka (JP)

(72) Inventor: Fumio SHINANO, Osaka (JP)

(73) Assignee: Panasonic Intellectual Property Management Co., Ltd., Osaka (JP)

(21) Appl. No.: 19/411,214

(22) Filed: Dec. 6, 2025

(30) Foreign Application Priority Data
Dec. 13, 2024 (JP) 2024-218841
Oct. 21, 2025 (JP) 2025-177348

(51) Int. Cl. G02B 7/04

(52) U.S. Cl. CPC G02B 7/04

(57) ABSTRACT

The lens barrel 10 includes a substantially cylindrical fixed barrel 23, a first lens group L1, a first lens frame 20, a distance scale ring 16, and a switching ring 22. The distance scale ring 16 is disposed at a position of being partially exposed, and displays a normal imaging scale display 16b and a macro imaging scale display 16c. The switching ring 22 is rotatably positioned on the outer periphery of the fixed barrel 23 and is operable by rotation to switch between a retracted state in which the normal imaging scale display 16b and the macro imaging scale display 16c are not displayed and the first lens frame 20 has moved away from the subject, a normal imaging state in which only the normal imaging scale display 16b is displayed and the first lens frame 20 has moved toward the subject side, and a macro imaging state in which only the macro imaging scale display 16c is displayed and the first lens frame 20 has moved further toward the subject side.

### CROSS-REFERENCE TO RELATED APPLICATIONS

This application claims priority to Japanese Patent Applications No. 2024-218841 filed on Dec. 13, 2024 and No. 2025-177348 filed on Oct. 21, 2025. The entire disclosure of Japanese Patent Applications No. 2024-218841 and No. 2025-177348 is hereby incorporated herein by reference.

### BACKGROUND

### Technical Field

The present disclosure relates to a lens barrel.

### Description of the Related Art

For example, Patent Literature 1 discloses a lens barrel that includes a lens unit having an optical system, a support frame that supports the lens unit so as to be movable in the optical axis direction of the optical system, a focus ring that is disposed around the outer periphery of the lens unit and is rotated relative to the lens unit when manual focus adjustment is performed, an operating unit that is provided so as to protrude outward in the radial direction from the focus ring and that is operated to rotate the focus ring, and a fixing unit that fixes the focus ring to the support frame when automatic focus adjustment is performed.

With this lens barrel, the fixing unit has a fixing button that is operated when the focus ring is fixed to the support frame, the fixing button is disposed on the operation unit, the lens barrel is provided with a distance scale ring having a first distance scale display that indicates distance in the normal imaging mode, and a second distance scale display that is formed parallel to the first distance scale display and indicates distance in the macro imaging mode, and the distance scale ring rotates together with the focus ring as the focus ring is turned, by engagement between the fixing button and a through-groove.

### CITATION LIST

### Patent Literature

Patent Literature 1: International Publication No. WO2016/143327.

### SUMMARY

### Problem to be Solved by the Invention

However, the following problem is encountered with the above-mentioned conventional lens barrel.

That is, with the lens barrel disclosed in the above publication, different distance scales can be displayed depending on the imaging mode, that is, a first distance scale is displayed in normal imaging mode and a second distance scale is displayed in macro imaging mode, but the size of the lens barrel in the optical axis direction during imaging is relatively large, making it inconvenient to carry around.

It is an object of the present disclosure to provide a lens barrel that can display different images depending on the imaging mode, and can reduce the size of the lens barrel in the optical axis direction when not imaging.

### Means for Solving Problem

The lens barrel according to the present disclosure is a lens barrel used in a state of being attached to an imaging device, and includes a substantially cylindrical fixed barrel, a lens group, a lens frame, a display unit, and a switching ring. The lens frame holds the lens group, is disposed on an inner diameter side of the fixed barrel, and is configured to be driven in an optical axis direction of the lens group. The display unit is disposed at a position at which at least a portion thereof is exposed on an outer peripheral surface, and is configured to display a first display and a second display different from the first display. The switching ring is rotatably disposed on an outer peripheral side of the fixed barrel and is configured to switch by a rotation operation between a retracted state in which neither the first display nor the second display is displayed and the lens frame has moved to an opposite side from a subject in the optical axis direction, a normal imaging state in which only the first display is displayed and the lens frame has moved toward a subject side in the optical axis direction, and a macro imaging state in which only the second display is displayed and the lens frame has moved further toward the subject side in the optical axis direction.

### Effects

The lens barrel according to the present disclosure allows different displays to be performed depending on the imaging mode, and reduces the size of the lens barrel in the optical axis direction when not imaging.

### BRIEF DESCRIPTION OF THE DRAWINGS

FIG. 1A is an overall oblique view of the configuration of a lens barrel on the subject side in an embodiment of the present disclosure;

FIG. 1B is an overall oblique view of the configuration of the lens mount side of the lens barrel in an embodiment of the present disclosure;

FIG. 2A is a side view of the lens barrel in FIG. 1A, etc. in a retracted state;

FIG. 2B is a side view of the lens barrel in FIG. 1A, etc. in a normal imaging state;

FIG. 2C is a side view of the lens barrel in FIG. 1A, etc. in a macro imaging state;

FIG. 3 is an exploded oblique view of the configuration of the lens barrel in FIG. 1A, etc.;

FIG. 4A is an oblique view of the configuration of an aperture ring included in FIG. 3;

FIG. 4B is a front view of the configuration of the aperture ring included in FIG. 3;

FIG. 5A is an oblique view of the configuration of a focus ring included in FIG. 3;

FIG. 5B is a front view of the configuration of the focus ring included in FIG. 3;

FIG. 6A is a see-through cross-sectional view of the configuration of the inner peripheral surface side of the distance scale ring included in FIG. 3;

FIG. 6B is an oblique view of the configuration of the distance scale ring included in FIG. 3;

FIG. 7 is an oblique view of the configuration of a cam pin frame included in FIG. 3;

FIG. 8A is an oblique view of the configuration of the subject side of the movable ring frame included in FIG. 3;

FIG. 8B is an oblique view of the configuration of the movable ring frame included in FIG. 3 on the opposite side from the subject;

FIG. 9A is an oblique view of the configuration of the subject side of the movable ring frame unit including the movable ring frame in FIG. 8A, etc.;

FIG. 9B is an oblique view of the configuration of the movable ring frame unit in FIG. 9A on the opposite side from the subject;

FIG. 10 is an exploded oblique view showing a state in which an encoder base and an encoder are mounted on the movable ring frame in FIG. 8A, etc.;

FIG. 11 is an oblique view of the configuration of the depth scale ring included in FIG. 3;

FIG. 12 is an oblique view of the configuration of a switching ring included in FIG. 3;

FIG. 13A is an oblique view of the configuration of the subject side of the fixed barrel included in FIG. 3;

FIG. 13B is an oblique view of the configuration of the fixed barrel in FIG. 13A on the opposite side from the subject;

FIG. 14A is a side view of the configuration of the cam barrel included in FIG. 3;

FIG. 14B is an oblique view of the configuration of the cam barrel in FIG. 14A;

FIG. 15A is a side view showing the position of the cam pin relative to the cam groove of the fixed barrel when the lens barrel is in the retracted state in FIG. 2A, etc.;

FIG. 15B is a side view showing the position of the cam pin relative to the cam groove of the fixed barrel in the normal imaging state of the lens barrel in FIG. 2B etc.;

FIG. 15C is a side view showing the position of the cam pin relative to the cam groove of the fixed barrel in the macro imaging state of the lens barrel in FIG. 2A etc.;

FIG. 16A is a cross-sectional view showing the internal positional relationship in the retracted state of the lens barrel in FIG. 15A, etc.;

FIG. 16B is a cross-sectional view showing the internal positional relationship of the lens barrel in the normal imaging state in FIG. 15B, etc.;

FIG. 16C is a cross-sectional view showing the internal positional relationship in the macro imaging state of the lens barrel in FIG. 15A, etc.;

FIG. 17 is a detail cross-sectional view of the components of the lens barrel in the macro imaging state in FIG. 16C;

FIG. 18 is an oblique view of the mated state of the switching ring in the macro imaging state shown in FIG. 16C, etc.;

FIG. 19 is a development diagram showing the positional relationship of the cam pin in various states relative to the cam barrel and the fixed barrel included in FIG. 3;

FIG. 20A is a side view showing the retracted state of the lens barrel according to another embodiment of the present disclosure;

FIG. 20B is a side view showing the lens barrel in FIG. 20A in the normal imaging state;

FIG. 20C is a side view showing the macro imaging state of the lens barrel in FIG. 20A;

FIG. 21 is an overall oblique view showing the retracted state of the lens barrel according to yet another embodiment of the present disclosure;

FIG. 22 is an oblique view showing the positional relationship between a focus grip unit and a protrusion provided on the depth scale ring in manual imaging mode in the normal imaging state of the lens barrel in FIG. 21;

FIG. 23 is an exploded oblique view of the configuration of a focus ring unit and a focus grip of the lens barrel in FIG. 21;

FIG. 24 is an oblique view of the configuration of the inner peripheral surface side of the focus ring unit in FIG. 23;

FIG. 25A is an oblique view of the configuration of the outer surface side of a focus grip main body included in the focus grip unit in FIG. 23;

FIG. 25B is an oblique view of the configuration of the inner surface side of the focus grip main body included in the focus grip unit in FIG. 23;

FIG. 26A is an oblique view of the configuration of the operation side of a slide switch included in the focus grip unit in FIG. 23;

FIG. 26B is an oblique view of the configuration on the opposite side from the operation side of the slide switch in FIG. 26A;

FIG. 27 is an oblique view of the configuration of a stopper included in the focus grip unit in FIG. 23;

FIG. 28A is a detail oblique view showing the positional relationship between the focus grip unit and the protrusion provided to the depth scale ring, when the lens barrel of FIG. 21 is in its retracted state;

FIG. 28B is a detail oblique view showing the positional relationship between the focus grip unit and the protrusion provided to the depth scale ring, when the focus ring of the lens barrel in FIG. 21 is in the AF position and the slide switch is in the ON state;

FIG. 28C is a detail oblique view showing the positional relationship between the focus grip unit and the protrusion provided to the depth scale ring, when the focus ring of the lens barrel in FIG. 21 is in the AF position and the slide switch is in the OFF state;

FIG. 29A is an oblique view showing the internal configuration of the focus grip unit in FIG. 23 when the focus grip unit is in its retracted state and switching is impossible between the AF position and the MF position;

FIG. 29B is an oblique view of the configuration of the operation side of the focus grip unit in FIG. 29A;

FIG. 29C is a cross-sectional view of the focus grip unit in the state in FIG. 29A;

FIG. 30A is an oblique view of the internal configuration of the focus grip unit in FIG. 23 in an ON state in which switching between the AF position and the MF position by the focus grip unit is impossible;

FIG. 30B is an oblique view of the configuration of the operation side of the focus grip unit in FIG. 30A;

FIG. 30C is a cross-sectional view of the focus grip unit in the state in FIG. 30A;

FIG. 31A is an oblique view of the internal configuration of the focus grip unit in FIG. 23 in an OFF state in which switching between an AF position and an MF position by the focus grip unit is possible;

FIG. 31B is an oblique view of the configuration of the operation side of the focus grip unit in FIG. 31A;

FIG. 31C is a cross-sectional view of the focus grip unit in the state in FIG. 31A;

FIG. 32A is a cross-sectional view showing the positional relationship between the parts of the focus grip unit and the depth scale ring when the lens barrel in FIG. 21 is in its retracted state;

FIG. 32B is a cross-sectional view showing the positional relationship between the parts of the focus grip unit and the depth scale ring when the lens barrel in FIG. 21 is in its normal imaging state and the slide switch is in the ON state;

FIG. 32C is a cross-sectional view showing the positional relationship between the parts of the focus grip unit and the depth scale ring when the lens barrel in FIG. 21 is in its normal imaging state and the slide switch is in the OFF state;

FIG. 33A is a diagram showing a state in which the stopper of the focus grip unit cannot go past the protrusion of the depth scale ring when the lens barrel of FIG. 21 is in its retracted state, and switching between AF mode and MF mode is impossible;

FIG. 33B is a diagram showing a state in which the lens barrel in FIG. 21 is in its normal imaging state or macro imaging state, and the slide switch is in the ON state, so the stopper of the focus grip unit goes past the protrusion of the depth scale ring, making switching between AF mode and MF mode impossible;

FIG. 33C is a diagram showing a state in which the lens barrel in FIG. 21 is in its normal imaging state or macro imaging state, and the slide switch is in the OFF state, so the stopper of the focus grip unit goes past the protrusion of the depth scale ring, making switching between AF mode and MF mode possible;

FIG. 34A is an external side view of the lens barrel in FIG. 21 in its retracted state;

FIG. 34B is an external view of the retracted state in FIG. 34A as seen from the subject side;

FIG. 34C is an external side view showing the position of the focus grip unit in the retracted state in FIG. 34A;

FIG. 35A is an external side view of the lens barrel in FIG. 21 in its normal imaging state and in the AF position;

FIG. 35B is an external view of the normal imaging state in FIG. 35A in the AF position, as seen from the subject side;

FIG. 35C is an external side view showing the position of the focus grip unit in the normal imaging state in FIG. 35A and in the AF position;

FIG. 36A is an external side view of the lens barrel in FIG. 21 in its normal imaging state and in the MF position;

FIG. 36B is an external view of the normal imaging state in FIG. 36A in the MF position, as seen from the subject side;

FIG. 36C is an external side view showing the position of the focus grip unit in the normal imaging state in FIG. 36A and in the MF position;

FIG. 37A is an external side view of the lens barrel in FIG. 21 in its macro imaging state and in the AF position;

FIG. 37B is an external view of the macro imaging state in FIG. 37A in the AF position, as viewed from the subject side;

FIG. 37C is an external side view showing the position of the focus grip unit in the macro imaging state in FIG. 37A and in the AF position;

FIG. 38A is an external side view of the lens barrel in FIG. 21 in its macro imaging state when the lens barrel is in the MF position;

FIG. 38B is an external view of the macro imaging state in FIG. 38A in the MF position, as seen from the subject side; and

FIG. 38C is an external side view showing the position of the focus grip unit in the macro imaging state in FIG. 38A and in the MF position.

### DETAILED DESCRIPTION OF THE EMBODIMENT

Embodiments will now be described with reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

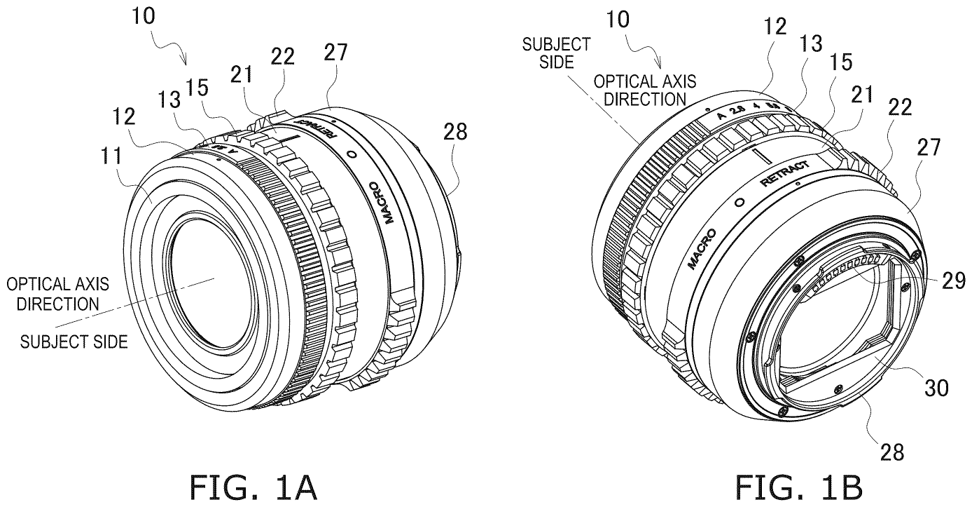

A lens barrel 10 according to an embodiment of the present disclosure will now be described with reference to FIGS. 1 to 19.

### (1) Overall Configuration of Lens Barrel 10

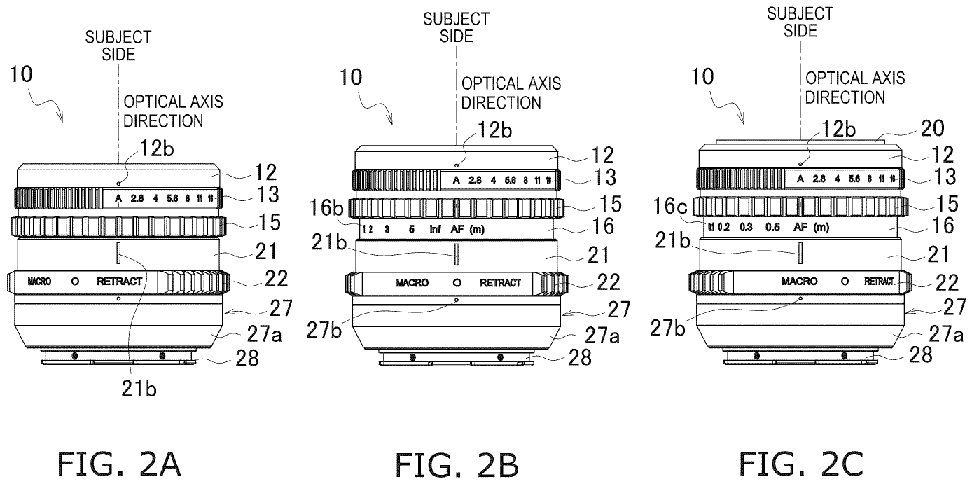

As shown in FIGS. 1A and 1B, the lens barrel 10 according to this embodiment is removably attached to a camera body (not shown) and captures an image of a subject. The lens barrel 10 has a built-in optical system that moves in the optical axis direction between a retracted state shown in FIG. 2A, a normal imaging state shown in FIG. 2B, and a macro imaging state shown in FIG. 2C, and thereby performs normal imaging and macro (close-up) imaging, while the size of lens barrel 10 in the optical axis direction is kept small when not in use for imaging.

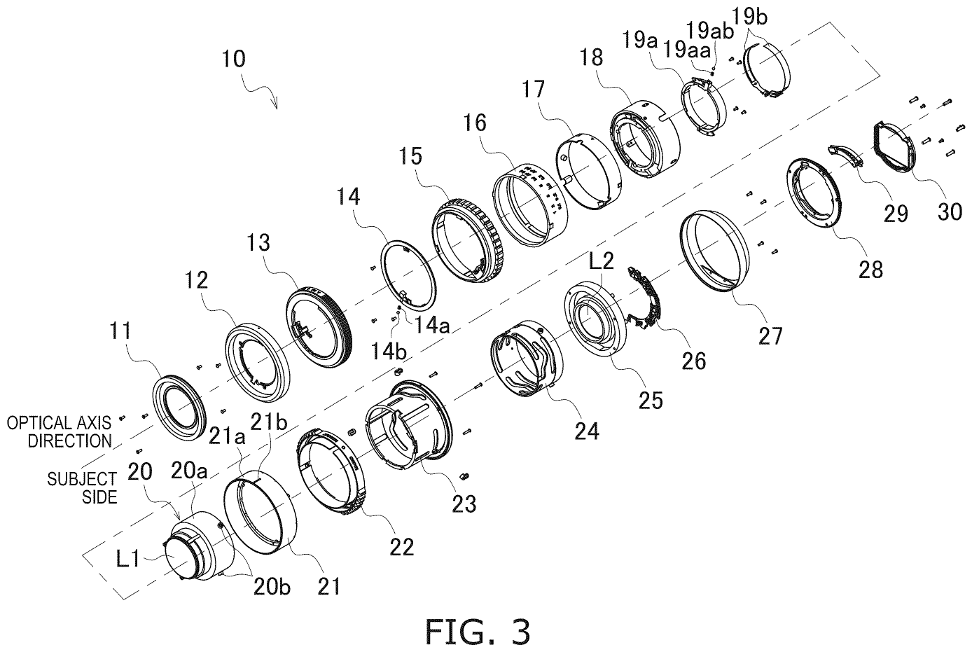

As shown in FIG. 3, the lens barrel 10 includes a filter ring 11, an index ring 12, an aperture ring 13, a presser ring 14, a focus ring 15, a distance scale ring (display unit) 16, a cam pin frame 17, a movable ring frame (movable frame) 18, an encoder base 19a, an encoder 19b, a first lens frame 20, a depth scale ring 21, a switching ring 22, a fixed barrel 23, a cam barrel 24, a second lens frame 25, a control board 26, a rear frame 27, a lens mount 28, a contact unit 29, and a light-shielding frame 30.

As shown in FIG. 3, the filter ring 11 is a substantially annular member that includes a screw on the inner peripheral surface to which an optical filter is attached, and is provided, and serves to protect a first lens group (lens group) L1, for example. The filter ring 11 is attached to the inner peripheral surface side of the substantially annular index ring 12.

As shown in FIG. 3, the index ring 12 is a substantially annular member provided on the subject side in the optical axis direction, and has a mark on its outer peripheral surface that indicates a reference position in the rotation direction around the optical axis when the aperture ring 13 is turned.

The aperture ring 13 is a ring-shaped member used to adjust the aperture of an aperture unit (not shown) housed within lens barrel 10, and is disposed on the subject side in the optical axis direction of the lens barrel 10, as shown in FIG. 3. The aperture ring 13 is turned by the user to adjust the aperture (the surface area of the opening through which light passes).

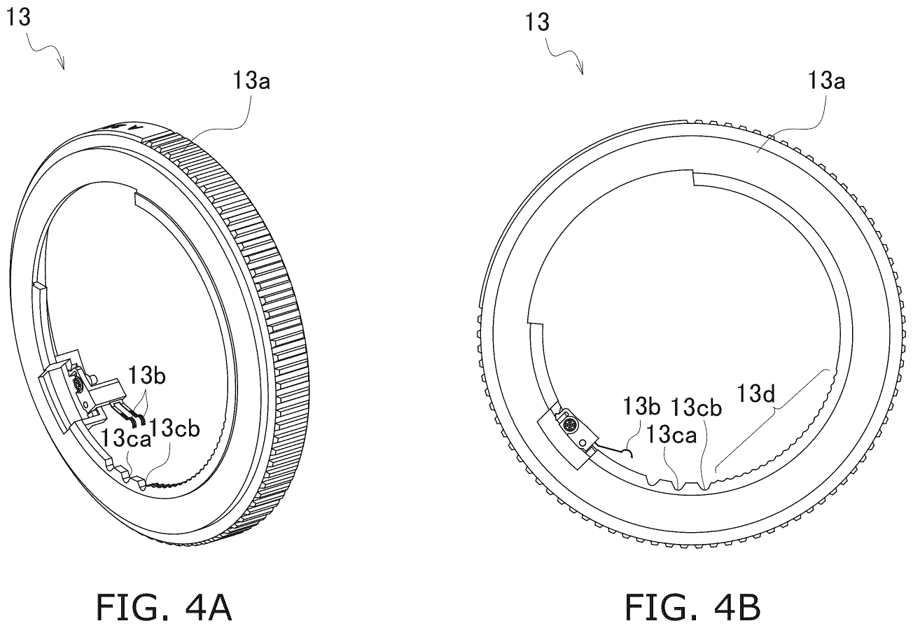

As shown in FIGS. 4A and 4B, the aperture ring 13 has an encoder brush 13b, click grooves 13ca and 13cb, and a click portion 13d, which are each provided on the inner peripheral surface of the substantially cylindrical main body portion 13a.

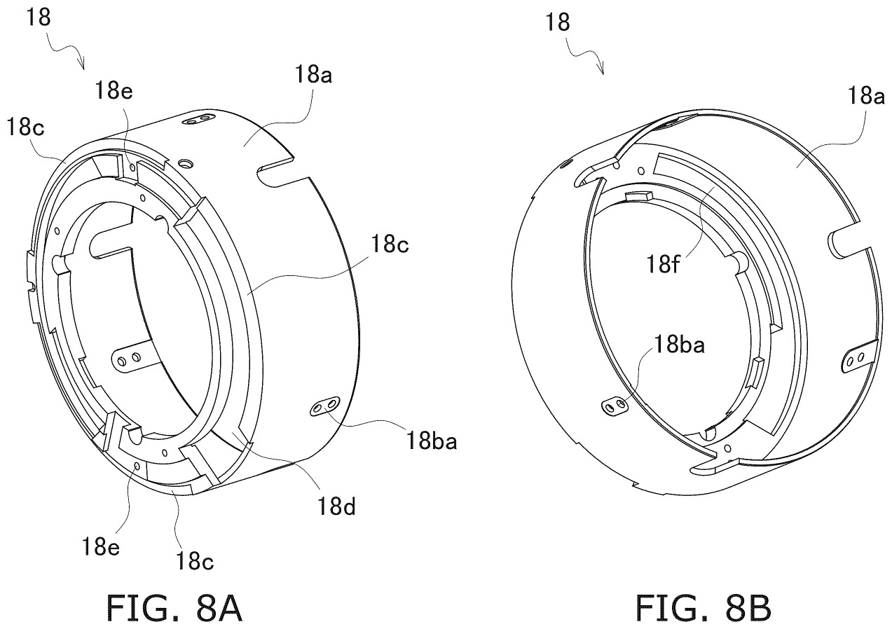

The encoder brush 13b is attached to the substantially annular inner peripheral surface of the aperture ring 13, and moves in the circumferential direction in a state of being inserted into a through-hole 18f (see FIG. 8B) in a movable ring frame 18 (discussed below).

The click groove 13ca is formed as a click position that holds the aperture ring 13 in the circumferential direction when the aperture ring 13 is turned to the auto position.

The click groove 13cb is formed as a click position at which the aperture ring 13 is held in the circumferential direction when the aperture ring 13 is turned to the manual aperture end.

The click portion 13d is constituted by a plurality of grooves formed continuously along the circumferential direction to generate a clicking sensation when the aperture ring 13 is turned within the manual aperture range.

The clicking sensation that occurs when the aperture ring 13 is turned is generated by the movement of a spring 14a and a click ball 14b (see FIG. 3) provided to the presser ring 14.

As shown in FIG. 3, the presser ring 14 is a substantially annular member that is attached to the fixed barrel 23 on the subject side of the focus ring 15. The presser ring 14 is provided to prevent the aperture ring 13 from rotating when the focus ring 15 is turned, or to prevent the focus ring 15 from rotating when aperture ring 13 is turned.

As shown in FIG. 3, the focus ring 15 is a ring-shaped member disposed adjacent to the aperture ring 13, and adjusts the focus of a subject image formed on an image sensor provided on the camera body side, by means of an optical system (first lens group L1 and second lens group L2) contained in lens barrel 10. The focus ring 15 is turned in manual focus mode to manually adjust the focus.

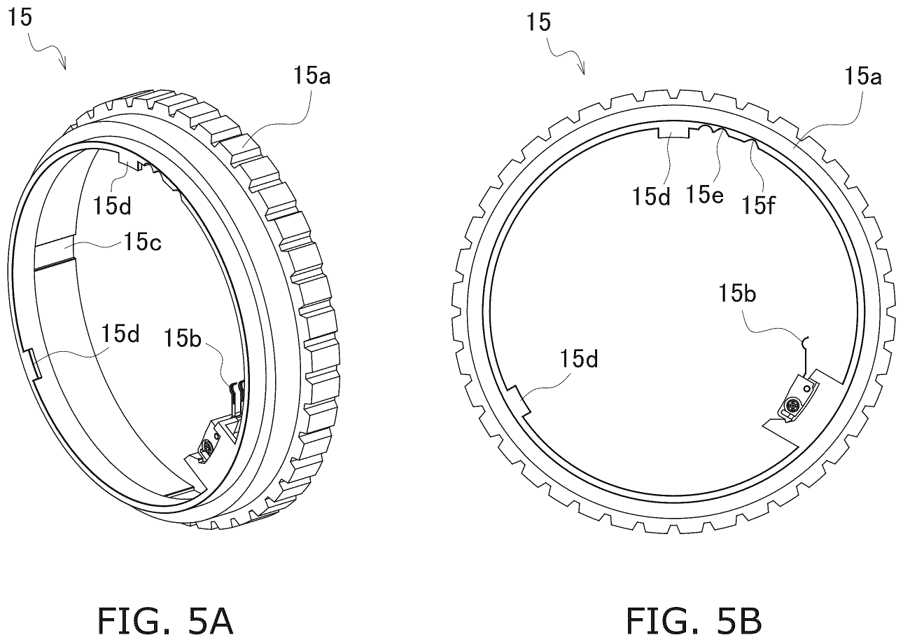

Also, as shown in FIGS. 5A and 5B, the focus ring 15 has a substantially annular main body portion 15a, an encoder brush 15b, a rectilinear guide groove 15c, a bayonet 15d, and click grooves 15e and 15f.

The encoder brush 15b is attached on the inner peripheral surface side of the substantially cylindrical main body portion 15a, and moves in the circumferential direction in a state of being inserted into a through-hole 18d (see FIG. 8A) in a movable ring frame 18 (discussed below).

As shown in FIG. 5A, the rectilinear guide groove 15c is formed in the optical axis direction on the inner peripheral surface of the substantially cylindrical main body portion 15a, and protrusions 16d provided to the distance scale ring 16 (discussed below) engage in a state of being able to move in the optical axis direction.

As shown in FIG. 5A, the bayonet 15d is a convex part provided to the end on the subject side of the inner peripheral surface of the substantially cylindrical main body portion 15a, and by engaging with the movable ring frame 18, the focus ring 15 is attached in a state of being able to rotate in the circumferential direction relative to the movable ring frame 18.

The click groove 15e is provided near the bayonet 15d on the inner peripheral surface of the substantially cylindrical main body portion 15a in order to hold the focus ring 15 in the autofocus position. A click ball 19ab (see FIG. 3), which is biased outward in the radial direction by a spring 19aa provided on the encoder base 19a side, engages with the click groove 15e to produce a clicking sensation.

The click groove 15f is provided on the inner peripheral surface of the substantially cylindrical main body portion 15a, near the bayonet 15d and adjacent to the click groove 15e, in order to hold the focus ring 15 at the manual focus end position. Just as with the click groove 15e, the click groove 15f generates a clicking sensation upon engaging with the click ball 19ab (see FIG. 3) that is biased outward in the radial direction by the spring 19aa provided on the encoder base 19a side.

As shown in FIG. 3, the distance scale ring (display unit) 16 is a substantially annular member, and is disposed at a position where at least a portion is exposed on the outer peripheral surface of the lens barrel 10. The distance scale ring 16 displays a normal imaging scale display 16b and a macro imaging scale display 16c that is different from the normal imaging scale display 16b.

Also, the distance scale ring 16 is provided on the inner peripheral surface side of the focus ring 15 and the depth scale ring 21 in a state of being able to move back and forth in the optical axis direction. The distance scale ring 16 is disposed on the outer peripheral surface so that parts of it (the non-display surface, the normal imaging scale display (first display) 16b, and the macro imaging scale display (second display) 16c) are exposed from a gap between the focus ring 15 and the depth scale ring 21.

Furthermore, the distance scale ring 16 moves back and forth in the optical axis in conjunction with a transition to the retracted state, the normal imaging state, or the macro imaging state, which are switched in accordance with the rotation of the switching ring 22.

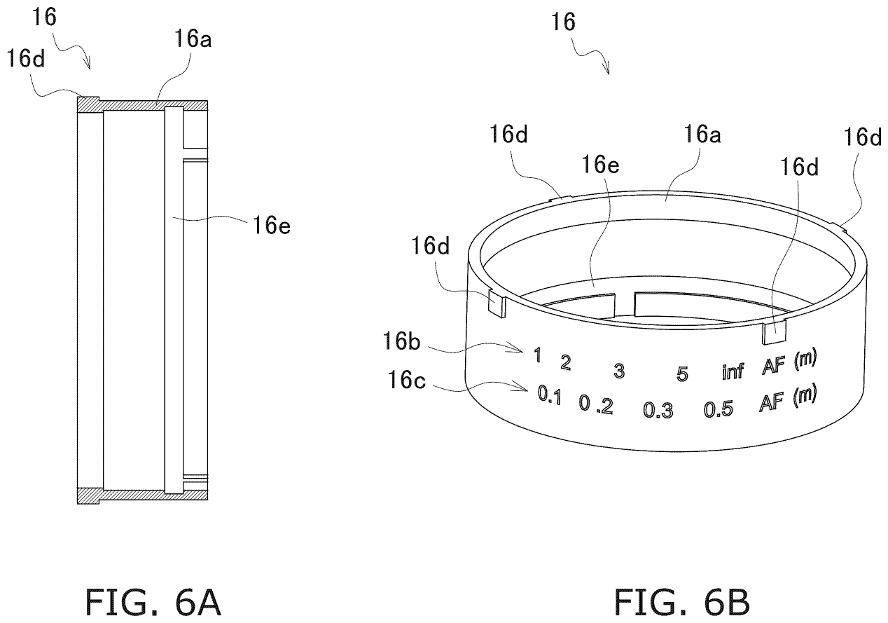

As shown in FIGS. 6A and 6B, the distance scale ring 16 has a substantially cylindrical main body portion (display main body portion) 16a, a normal imaging scale display 16b, a macro imaging scale display 16c, protrusions 16d, and a slide groove 16e.

The normal imaging scale display 16b is a distance scale display that is displayed on the outer peripheral surface of the lens barrel 10 in the normal imaging state, and is provided along the circumferential direction of the outer peripheral surface of the substantially cylindrical main body 16a. As shown in FIG. 6B, the normal imaging scale display 16b is disposed closer to the subject in the optical axis direction than the macro imaging scale display 16c.

The macro imaging scale display 16c is a distance scale display that is displayed on the outer peripheral surface of the lens barrel 10 in the macro imaging state, and is provided along the circumferential direction of the outer peripheral surface of the substantially cylindrical main body 16a, substantially parallel to the normal imaging scale display 16b. As shown in FIG. 6B, the macro imaging scale display 16c is disposed adjacent to the normal imaging scale display 16b, on the opposite side from the subject in the optical axis direction.

Four of the protrusions 16d are provided so as to protrude outward in the radial direction from four locations on the outer peripheral surface of the substantially annular main body 16a in order to synchronize the rotation of the focus ring 15 and the distance scale ring 16.

There may be one or more protrusions 16d provided on the outer peripheral surface of the substantially annular main body 16a to synchronize the rotation of the focus ring 15 and the distance scale ring 16.

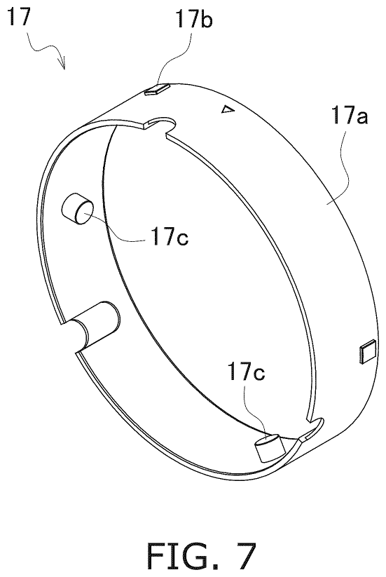

As shown in FIG. 6A, the slide groove 16e is a groove in which the protrusion 17b (see FIG. 7) provided to the cam pin frame 17 slides in an engaged state, and is provided on the inner peripheral surface side of the distance scale ring 16.

As shown in FIG. 3, the cam pin frame 17 is a substantially cylindrical member that is disposed on the inner peripheral surface side of the distance scale ring 16, and as shown in FIG. 7, has a substantially cylindrical main body portion 17a, protrusions 17b, and cam pins (third cam pins) 17c.

As shown in FIG. 7, the protrusions 17b are provided at four locations spaced apart substantially equally so as to protrude outward in the radial direction from the outer peripheral surface of the substantially cylindrical main body portion (cam pin frame main body portion) 17a, and move along the slide groove 16e formed in the inner peripheral surface of the distance scale ring 16. Consequently, the distance scale ring 16 moves in a rotatable state on the outer peripheral surface side of the cam pin frame 17, in a state of being integrated with the cam pin frame 17 in the optical axis direction.

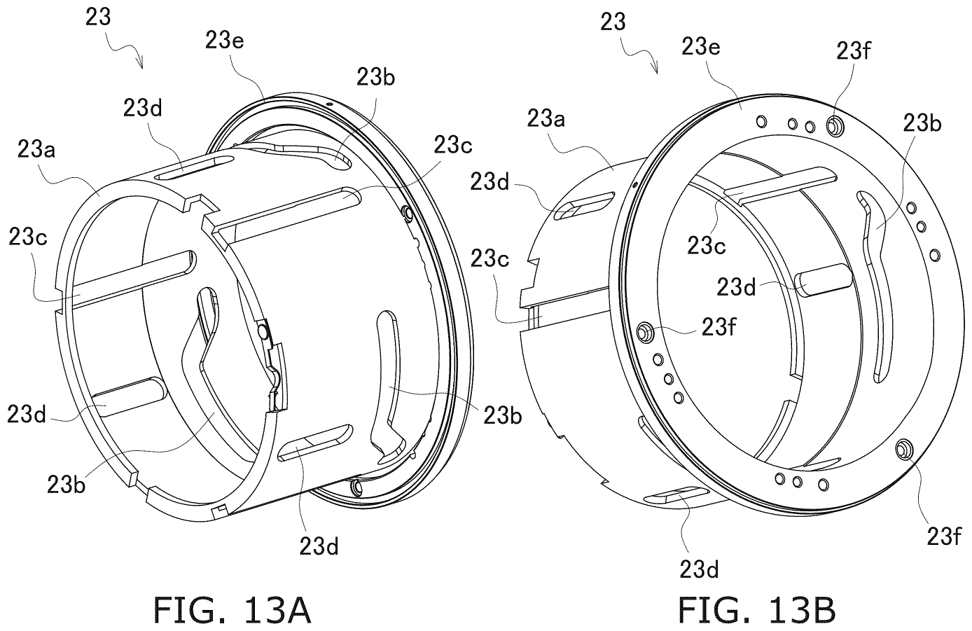

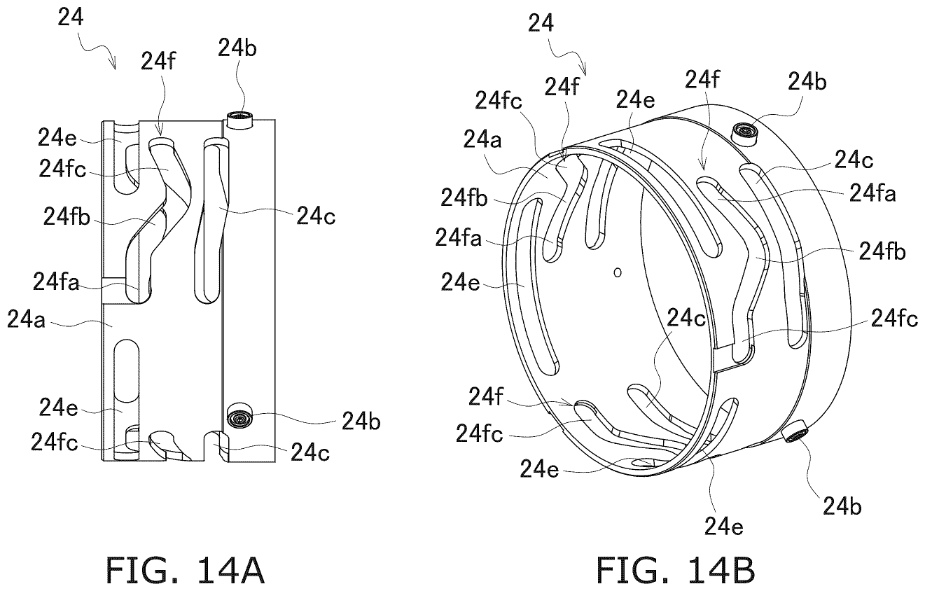

As shown in FIG. 7, the cam pins 17c are provided at three locations spaced apart substantially equally so as to protrude inward in the radial direction from the inner peripheral surface of the substantially cylindrical main body portion 17a. The cam pins 17c move in the optical axis direction and the circumferential direction in a state of being engaged with the rectilinear groove 23c of the fixed barrel 23 (see FIG. 13A, etc.) and the cam groove (display switching cam groove) 24f of the cam barrel 24 (see FIG. 14A, etc.).

As shown in FIG. 3, the movable ring frame (movable frame) 18 is a substantially cylindrical member that is provided on the inner peripheral surface side of the cam pin frame 17 and on the outer peripheral surface side of the fixed barrel 23 in a state of being rotatable in the circumferential direction.

Also, as shown in FIGS. 8A and 8B, the movable ring frame 18 has a main body portion (movable main body portion) 18a, cam pins (fourth cam pins) 18b, a sliding surface 18c, a through-hole 18d, a threaded hole 18e, and a through-hole 18f.

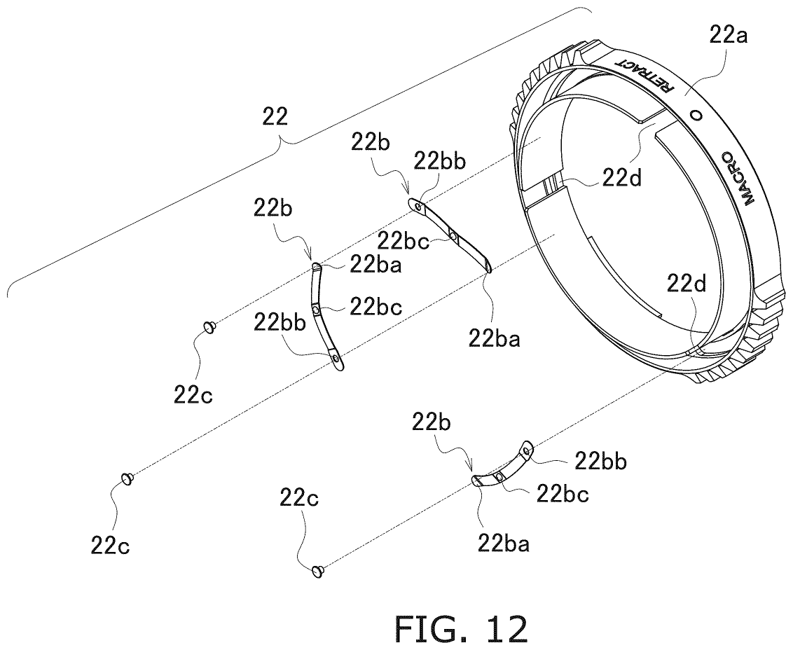

The cam pins (fourth cam pins) 18b are fixed with screws at positions where threaded holes 18ba are formed, so as to protrude inward in the radial direction from the inner peripheral surface of the substantially cylindrical main body portion 18a. The cam pins 18b are provided at three locations on the inner peripheral surface of the substantially cylindrical main body portion 18a at approximately 120-degree intervals. The cam pins 18b move in the optical axis direction in a state of being engaged with a rectilinear groove 23d (see FIG. 12A, etc.) provided to the fixed barrel 23 (discussed below).

As shown in FIG. 8A, the sliding surface 18c is the end surface opposite the subject in the optical axis direction, and slides in contact with the end surface of the focus ring 15 on the opposite side from the subject.

As shown in FIG. 8A, the through-hole 18d is formed in the end surface opposite the subject in the optical axis direction, and moves in the circumferential direction in a state in which the encoder brush 15b has been inserted.

As shown in FIG. 8A, the threaded hole 18e is provided on the fixed barrel 23 opposite the subject in the optical axis direction, and a screw for fixing the presser ring 14 is screwed into the threaded hole 18e.

As shown in FIG. 8B, the through-hole 18f is formed in the fixed barrel 23 opposite the subject in the optical axis direction, and the encoder brush 13b of the aperture ring 13 moves in the circumferential direction in a state in which the encoder brush 13b of the aperture ring 13 has been inserted.

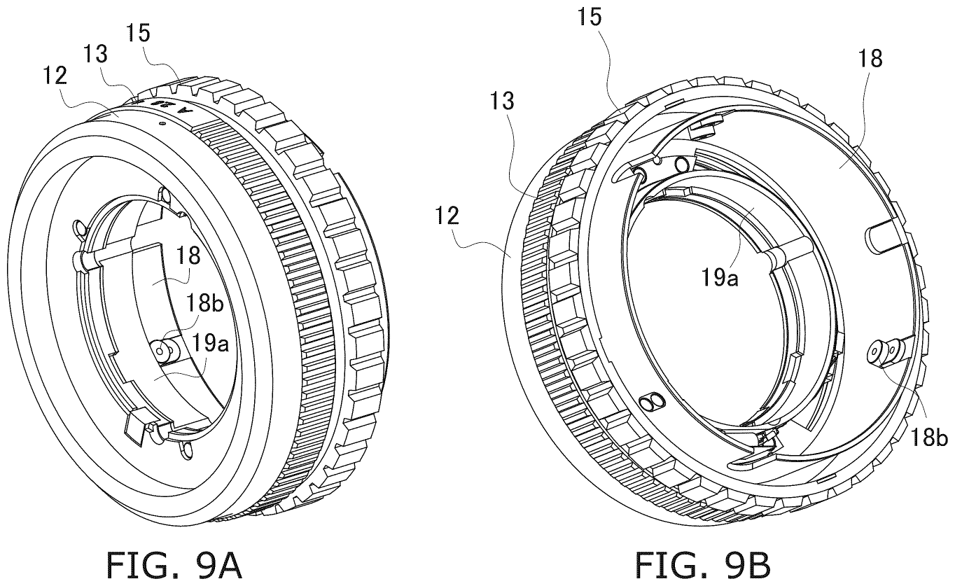

Furthermore, as shown in FIGS. 9A and 9B, the aperture ring 13 and the focus ring 15 are rotatably attached to the outer peripheral surface of the movable ring frame 18. The index ring 12 is attached on the subject side of the movable ring frame 18, and the encoder base 19a is attached on the inner peripheral surface side.

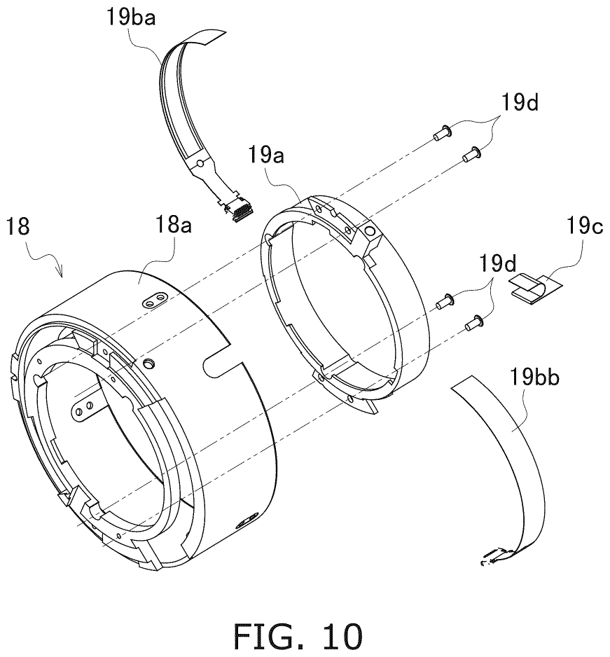

As shown in FIG. 3, the encoder base 19a is a substantially annular member, and the above-mentioned spring 19aa and click ball 19ab are provided at positions protruding from the outer peripheral surface thereof. As shown in FIG. 10, the encoder base 19a is fixed with four screws 19d to the inner peripheral surface side of the main body portion 18a of the movable ring frame 18, in a state in which an encoder 19ba for the aperture ring and an encoder 19bb for the focus ring have been attached to the outer peripheral surface thereof.

Also, as shown in FIG. 10, a connecting flexible cable 19c is attached to the encoder base 19a from the opposite side from the subject in the optical axis direction.

As shown in FIG. 3, the first lens frame 20 holds the first lens group L1, is disposed on the inner diameter side of the fixed barrel 23, and is driven in the optical axis direction of the first lens group L1. The first lens frame 20 is held on the inner peripheral surface side of the movable ring frame 18, the fixed barrel 23, etc., in a state of being able to move back and forth in the optical axis direction.

Also, in a transition from the normal imaging state shown in FIG. 2B to the macro imaging state shown in FIG. 2C, the first lens frame 20 moves so as to protrude toward the subject in the optical axis direction. Furthermore, as shown in FIG. 3, the first lens frame 20 has a substantially cylindrical main body portion (lens frame main body portion) 20a and cam pins (second cam pins) 20b that protrude outward in the radial direction from the outer peripheral surface of the main body portion 20a.

The cam pins 20b move back and forth in the optical axis direction in a state of being engaged with the rectilinear groove 23c of the fixed barrel 23 (discussed below), and moves in the circumferential direction in a state of being engaged with the cam groove 24c of the cam barrel 24 (discussed below).

Consequently, the first lens frame 20 is driven back and forth in the optical axis direction according to the relative rotation of the cam barrel 24.

As shown in FIG. 3, the depth scale ring 21 is a substantially cylindrical member that is disposed on the outer peripheral surface side of the distance scale ring 16 and the movable ring frame 18. A scale indicator 21b that indicates the depth of field when the focus ring 15 is turned is provided on the outer peripheral surface of the main body portion (movable main body portion) 21a of the depth scale ring 21.

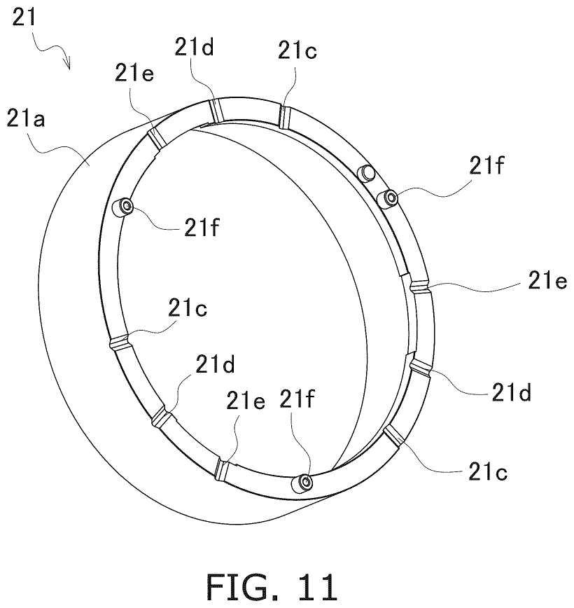

As shown in FIG. 11, the depth scale ring 21 has click grooves 21c, 21d, and 21e and a convex part 21f on the end surface of the substantially cylindrical main body portion 21a on the opposite side from the subject in the optical axis direction.

The click groove 21c engages with a convex part 22bc provided between the distal end portion 22ba and the hole 22bb of a click leaf spring 22b attached at a position opposite the switching ring 22 (discussed below), producing a clicking sensation when the switching ring 22 is turned and there is a transition to the retracted state shown in FIG. 2A.

The click groove 21d engages with a convex part 22bc provided between the distal end portion 22ba and the hole 22bb of the click leaf spring 22b attached at a position opposite the switching ring 22 (discussed below), producing a clicking sensation when the switching ring 22 is turned and there is a transition to the normal imaging state shown in FIG. 2B.

The click groove 21e engages with a convex part 22bc provided between the distal end portion 22ba and the hole 22bb of the click leaf spring 22b attached at a position opposite the switching ring 22 side (discussed below), producing a clicking sensation when the switching ring 22 is turned and there is a transition to the macro imaging state shown in FIG. 2C.

The convex parts 21f are provided on the end surface of the main body portion 21a so as to protrude toward the opposite side from the subject in the optical axis direction, and a threaded hole for a screw that is screwed in when fixing to the flange portion 23e of the fixed barrel 23.

As shown in FIG. 3, the switching ring 22 is a substantially cylindrical member that is rotatably mounted on the outer peripheral surface side of the fixed barrel 23, and is turned when switching the components of the lens barrel 10 between the retracted state shown in FIG. 2A (the distance scale ring 16 is not displayed), the normal imaging state shown in FIG. 2B (the normal imaging scale display 16b on the distance scale ring 16), and the macro imaging state shown in FIG. 2C (the macro imaging scale display 16c on the distance scale ring 16).

That is, the switching ring 22 is disposed in a rotatable state on the outer peripheral side of the fixed barrel 23, and is turned to switch between a retracted state in which the normal imaging scale display (first display) 16b and the macro imaging scale display (second display) 16c are not displayed and the first lens frame 20 has moved to the opposite side from the subject in the optical axis direction; a normal imaging state in which only the normal imaging scale display 16b is displayed and the first lens frame 20 has moved to the subject side in the optical axis direction; and a macro imaging state in which the macro imaging scale display 16c is displayed and the first lens frame 20 has moved further to the subject side in the optical axis direction.

Also, as shown in FIG. 12, the switching ring 22 has a substantially cylindrical main body portion 22a, a click leaf spring 22b, a screw 22c, and a rectilinear groove 22d.

The outer peripheral surface of the substantially cylindrical main body portion 22a is provided with displays of “RETRACT” corresponding to the retracted state, “◯” corresponding to the normal imaging state, and “MACRO” corresponding to the macro imaging state.

The click leaf springs 22b are fixed with screws 22c at three locations to the end surface of the main body portion 22a on the subject side in the optical axis direction, and each has a distal end portion 22ba, a hole 22bb, and a convex part 22bc.

The distal end portion 22ba is provided at the end on the opposite side from the hole 22bb in which the main body portion 22a is fixed, and is bent so as to protrude in the optical axis direction more than the portion where the hole 22bb is provided. The distal end portions 22ba engage with the click grooves 21c, 21d, and 21e provided on the end surface of the depth scale ring 21.

Consequently, a clicking sensation is produced when the switching ring 22 is turned relative to the depth scale ring 21 and there is a transition to the retracted state, normal imaging state, or macro imaging state.

The screws 22c are inserted into the holes 22bb, and the screws 22c are threaded into screw holes on the main body portion 22a side, thereby fixing the click leaf springs 22b to the main body portion 22a.

The convex parts 22bc are provided between the distal end portions 22ba and the holes 22bb, and engage with the click grooves 21c, 21d, and 21e provided to the fixed barrel 23 of the depth scale ring 21. This allows a clicking sensation to be produced when the switching ring 22 is turned to switch between the retracted state, the normal imaging state, and the macro imaging state.

A cam pin 24b (see FIG. 14A, etc.) that is provided so as to protrude outward in the radial direction from the outer peripheral surface of a cam barrel 24 (discussed below) moves back and forth in the optical axis direction in a state of being engaged with the rectilinear groove 22d.

As shown in FIG. 3, the fixed barrel 23 is a member having a substantially cylindrical shape, and the inner peripheral surface side thereof is provided with the first lens frame 20, the cam barrel 24, etc. The focus ring 15, the distance scale ring 16, the cam pin frame 17, the movable ring frame 18, the depth scale ring 21, the switching ring 22, etc., are disposed on the outer peripheral surface side of the fixed barrel 23.

As shown in FIGS. 13A and 13B, the fixed barrel 23 has a main body portion (fixed main body portion) 23a, cam grooves (first cam grooves) 23b, rectilinear grooves (first rectilinear grooves) 23c, rectilinear grooves (second rectilinear grooves) 23d, a flange portion 23e, and recesses 23f.

As shown in FIGS. 13A and 13B, the main body portion (fixed main body portion) 23a is a substantially cylindrical member, and has the flange portion 23e on the opposite side from the subject in the optical axis direction. The main body portion 23a has the cam grooves 23b formed along the circumferential direction and the rectilinear grooves 23c and 23d formed along the optical axis direction.

As shown in FIGS. 13A and 13B, the cam grooves (first cam grooves) 23b are provided so that the inner and outer peripheral surfaces of substantially cylindrical main body portion 23a can communicate. The cam grooves 23b allow the cam pins 24b of the cam barrel 24 to move in an engaged state in a transition from the retracted state to the normal imaging state.

Consequently, when the switching ring 22 is turned and there is a transition from the retracted state to the normal imaging state, the cam barrel 24 can be moved to the subject side in the optical axis direction relative to the fixed barrel 23.

As shown in FIGS. 13A and 13B, the rectilinear grooves (first rectilinear grooves) 23c are provided linearly in the optical axis direction so as to allow the inner peripheral surface and the outer peripheral surface of the substantially cylindrical main body portion 23a to communicate. The rectilinear grooves 23c allow the cam pins 20b of the first lens frame 20 and the cam pins 17c of the cam pin frame 17 to move in the optical axis direction in a state of being engaged.

As shown in FIGS. 13A and 13B, the rectilinear grooves (second rectilinear grooves) 23d are provided running along the optical axis direction so as to allow the inner and outer peripheral surfaces of the substantially cylindrical main body portion 23a to communicate. The rectilinear grooves 23d are formed so as to be shorter in length in the optical axis direction than the rectilinear grooves 23c. The rectilinear grooves 23d allow the cam pins 18b provided to the movable ring frame 18 to move in a state of being engaged.

Consequently, the movable ring frame 18 can move back and forth in the optical axis direction relative to the fixed barrel 23 while being unable to rotate relative to the fixed barrel 23.

The flange portion 23e is provided to the end of the substantially cylindrical main body portion 23a on the opposite side from the subject in the optical axis direction, and forms a flange that protrudes in the radial direction beyond the main body portion 23a.

The recesses 23f are provided on the end surface of the flange portion 23e on the opposite side from the subject, and are screwed down on the opposite side from the subject in a state in which the convex parts 21f provided on the depth scale ring 21 have been inserted. This allows the depth scale ring 21 to be fixed to the fixed barrel 23 in a state of being non-rotatable in the circumferential direction.

As shown in FIG. 3, the cam barrel 24 is a substantially cylindrical member, and is rotatably disposed on the inner peripheral surface side of the fixed barrel 23.

As shown in FIGS. 14A and 14B, the cam barrel 24 has a main body portion (cam main body portion) 24a, cam pins (first cam pins) 24b, cam grooves (second cam grooves) 24c, cam grooves (synchronization cam grooves) 24e, and cam grooves (display switching cam grooves) 24f.

The main body portion (cam main body portion) 24a is a substantially cylindrical member, and the cam grooves 24e, 24f, and 24c are formed in that order starting from the subject side in the optical axis direction.

As shown in FIGS. 14A and 14B, three cam pins (first cam pins) 24b are provided at approximately equal intervals in the circumferential direction so as to protrude outward in the radial direction from positions on the outer peripheral surface of the substantially cylindrical main body portion 24a, toward the opposite side from the subject. The cam pins 24b move while engaged with the cam grooves 23b provided in the fixed barrel 23, as the switching ring 22 is turned.

This allows the lens barrel 10 to transition from its retracted state (FIG. 2A) to its normal imaging state (FIG. 2B).

As shown in FIGS. 14A and 14B, three cam grooves (second cam grooves) 24c are provided at approximately equal intervals along the circumferential direction of the substantially cylindrical main body portion 24a, toward the opposite side from the subject. The cam grooves 24c are formed along the circumferential direction and bent near the center, with half of each groove being offset in the optical axis direction. When the switching ring 22 is turned to switch from the normal imaging mode to the macro imaging mode, the cam grooves 24c allow the cam pins 20b of the first lens frame 20 to move in a state of being engaged.

Consequently, when the first lens frame 20 is moved closer to the subject than in the normal imaging state, the lens barrel 10 can be switched from its normal imaging state (FIG. 2B) to its macro imaging state (FIG. 2C).

As shown in FIGS. 14A and 14B, the cam grooves (synchronization cam grooves) 24e are formed linearly along the circumferential direction of the substantially cylindrical main body portion 24a at positions closer to the subject, and three of these grooves are provided at approximately equal intervals. The cam grooves 24e allow the cam pins 18b (see FIG. 9B, etc.) of the movable ring frame 18 to move in the circumferential direction in a state of being engaged.

Consequently, the movable ring frame 18 can be moved in the optical axis direction in a state of being synchronized with the cam barrel 24 (a state of being incapable of relative motion in the optical axis direction).

Three cam grooves (display switching cam grooves) 24f are provided at approximately equal intervals along the circumferential direction of the substantially cylindrical main body portion 24a, at positions in between cam grooves 24c and 24e in the optical axis direction. The cam grooves 24f allow the cam pins 17c of the cam pin frame 17 to move in an engaged state when the switching ring 22 is turned, thereby allowing the cam pin frame 17, which is integrated with the distance scale ring 16 in the optical axis direction, to move back and forth in the optical axis direction.

As shown in FIGS. 14A and 14B, the cam grooves 24f are each configured to include a groove portion (first groove portion) 24fa, a groove portion (interference avoidance groove portion) 24fb, and a groove portion (second groove portion) 24fc.

As shown in FIG. 14A, the groove portion (first groove portion) 24fa is formed along the circumferential direction at the position of the cam groove 24f that is closest to the subject. The groove portion 24fa positions the cam pin 17c of the cam pin frame 17 when lens barrel 10 is in its retracted state.

The groove portions (interference avoidance groove portions) 24fb guide the cam pins 17c of the cam pin frame 17 to the opposite side from the subject in a transition from the retracted state to the normal imaging state, which moves the distance scale ring 16 to the subject side in the optical axis direction. As shown in FIG. 14A, groove portions 24fb are connected to the groove portions 24fa via a portion that is bent to the opposite side from the subject beyond the groove portions 24fa, and are formed along the circumferential direction. The groove portions 24fb are where the cam pins 17c of cam pin frame 17 are located when the lens barrel 10 is in its normal imaging state.

As shown in FIG. 14A, the groove portions 24fc (second groove portions) are connected to the groove portions 24fb via a portion where groove portions 24fb are bent again toward the subject, and are formed along the circumferential direction. The cam pins 17c of cam pin frame 17 are located in the groove portions 24fc when the lens barrel 10 is in its macro imaging state.

With the lens barrel 10 of this embodiment, the configuration is such that cam grooves 24f which receive the protrusions 17b of the cam pin frame 17, which moves in the optical axis direction integrally with the distance scale ring 16 depending on the retracted state, normal imaging state, or macro imaging state, include interference avoidance groove portions 24fb that temporarily allow escape to the opposite side from the subject in a transition to the normal imaging state.

Consequently, even though the lens barrel 10 is smaller in the optical axis direction, the amount of movement of the distance scale ring 16 is less than the amount of movement of the movable ring frame 18 in a transition from the retracted state to the normal imaging state, and this prevents the distance scale ring 16 from interfering with other components (such as the depth scale ring 21, etc.).

As shown in FIG. 3, the second lens frame 25 is a substantially annular member, and is disposed adjacent to the fixed barrel 23 on the opposite side from the subject, in a state of holding the second lens group L2.

As shown in FIG. 3, the control board 26 is provided near the end of the lens barrel 10 on the opposite side from the subject in the optical axis direction. The control board 26 controls an actuator (not shown) that varies the relative positions of the first lens group L1 and the second lens group L2.

As shown in FIG. 3, the rear frame 27 is a substantially cylindrical member that is disposed farther away from the subject in the optical axis direction than any of the other components constituting the lens barrel 10, and is attached to a mounting portion on the camera body side (not shown).

As shown in FIG. 2B, etc., the rear frame 27 has a substantially cylindrical main body portion 27a and an indicator 27b that indicates whether the current state is the retracted state, normal imaging state, or macro imaging state when the switching ring 22 is turned.

As shown in FIG. 3, the lens mount 28 is a substantially annular member that is provided on the opposite side from the subject in the optical axis direction, and is mounted to the lens mount provided on the camera body side (not shown) by a bayonet connection, for example.

As shown in FIG. 3, the contact unit 29 is a substantially arc-shaped part that is disposed on the inner peripheral surface side of the lens mount 28 and comes into contact with a contact provided on the camera body side (not shown).

As shown in FIG. 3, the light-shielding frame 30 is a substantially annular member that is disposed between the lens mount 28 and the camera body, and is used to block unnecessary light.

### Switching Between Retracted, Normal and Macro Imaging Modes

With the above configuration, the lens barrel 10 of this embodiment switches between the retracted state shown in FIG. 2A, the normal imaging state shown in FIG. 2B, and the macro imaging state shown in FIG. 2C as the switching ring 22 is turned.

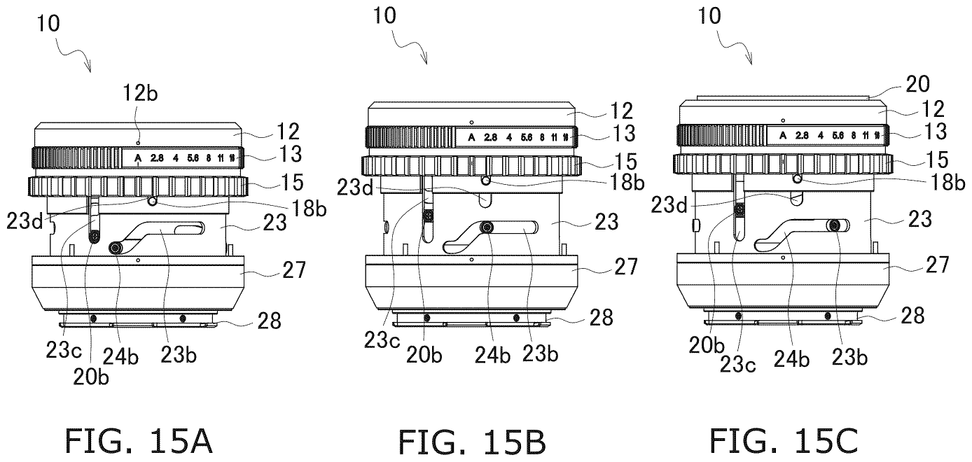

The movement inside the lens barrel 10 when switching between these three states will now be described with reference to FIGS. 15A to 19.

FIGS. 15A to 15C show a configuration in which the distance scale ring 16 and the switching ring 22 are not depicted, for the sake of simplicity.

As shown in FIG. 15A, in the retracted state of the lens barrel 10 of this embodiment, the cam pins 24b provided on the outer peripheral surface of the cam barrel 24 are located at the end (left end in the drawing) of the cam grooves 23b provided to the fixed barrel 23, on the opposite side from the subject. At the same time, the cam pins 20b provided on the outer peripheral surface of first lens frame 20 are engaged with the cam grooves 24c of cam barrel 24 disposed on the inner peripheral surface side of the fixed barrel 23, and in this state are located at the end of the rectilinear grooves 23c provided to the fixed barrel 23 that is farthest away from the subject. Furthermore, the cam pins 18b provided on the inner peripheral surface of movable ring frame 18 are located at the end of the rectilinear grooves 23d provided on the fixed barrel 23 that is farthest away from the subject.

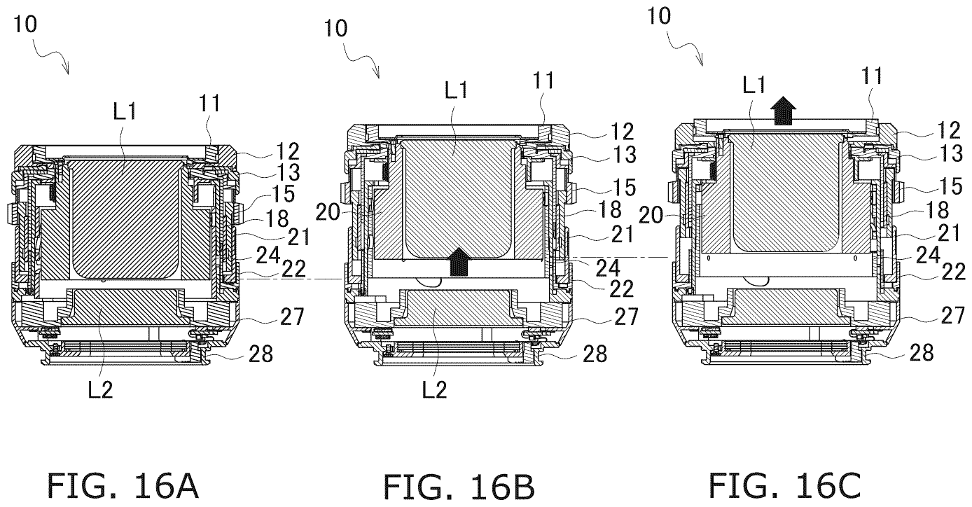

At this point, as shown in FIG. 16A, the unit including the movable ring frame 18 and so forth that are movable in the optical axis direction relative to the fixed barrel 23 is positioned at the opposite end that is farthest away from the subject, which minimizes the size of the lens barrel 10 in the optical axis direction.

Next, when the switching ring 22 is turned to switch from the retracted state to the normal imaging state, as shown in FIG. 15B, cam pins 24b on the outer peripheral surface of cam barrel 24 move in steps in the circumferential direction along the cam grooves 23b provided to the fixed barrel 23, thereby moving cam barrel 24 to the subject side in the optical axis direction. At the same time, the cam pins 20b on the outer peripheral surface of first lens frame 20 move to the subject side along the rectilinear grooves 23c provided to the fixed barrel 23. Furthermore, the cam pins 18b on the inner peripheral surface of the movable ring frame 18 move to the subject side along rectilinear grooves 23d provided to the fixed barrel 23.

At this point, the cam barrel 24 is integrated in the optical axis direction with the unit including the movable ring frame 18. Therefore, as shown in FIG. 16B, the cam barrel 24 moves to the subject side in the optical axis direction along with the unit including the movable ring frame 18.

Furthermore, when the switching ring 22 is turned to switch from the normal imaging state to the macro imaging state, as shown in FIG. 15C, the cam pins 24b provided on the outer peripheral surface of the cam barrel 24 move along the cam grooves 23b provided to the fixed barrel 23 to near the right end in the drawing. Here, the cam pins 20b provided on the outer peripheral surface of the first lens frame 20 remain in their original positions in the rectilinear grooves 23c provided to the fixed barrel 23. Furthermore, the cam pins 18b provided on the inner peripheral surface of the movable ring frame 18 remain in their original positions in the rectilinear grooves 23d provided to the fixed barrel 23.

At this point, as shown in FIG. 16C, the position of the cam barrel 24 is held at the same position as in the normal imaging state, while the first lens frame 20 moves to the subject side in the optical axis direction.

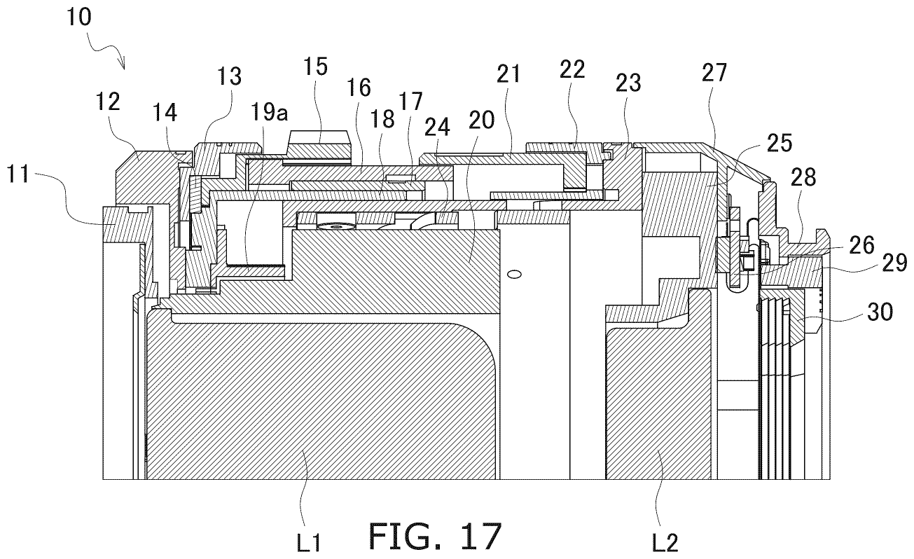

Consequently, as shown in FIG. 17, in the macro imaging state, the first lens frame 20 holding the first lens group L1 moves to a position where the filter ring 11 integrated by screws protrudes to the subject side in the optical axis direction, and this changes the distance of the first lens group L1 relative to the second lens group L2 and allows macro imaging to be performed.

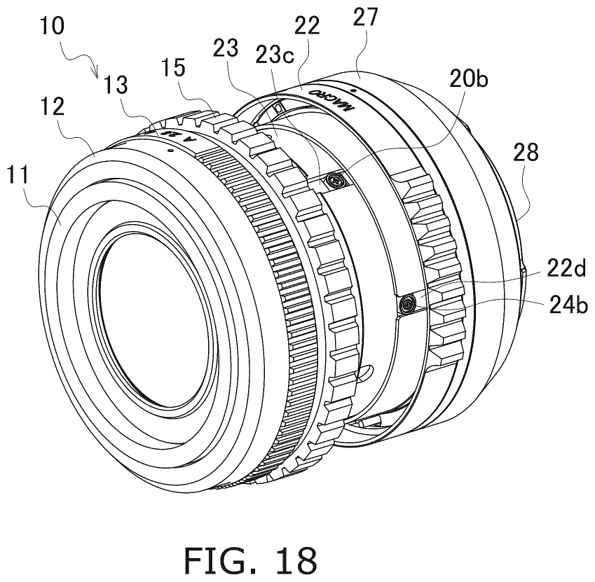

Here, the mated state of the switching ring 22 in a transition from the normal imaging state to the macro imaging state will now be described with reference to FIG. 18. For the sake of simplicity, FIG. 18 shows a configuration in which the distance scale ring 16 and the depth scale ring 21 are not depicted.

During a transition from the normal imaging state to the macro imaging state, as shown in FIG. 18, the cam pins 20b of the first lens frame 20 engage with the rectilinear grooves 23c of the fixed barrel 23, and in this state move in the optical axis direction, and the cam pins 24b of the cam barrel 24 engage with the rectilinear grooves 22d of the switching ring 22, and in this state move in the optical axis direction.

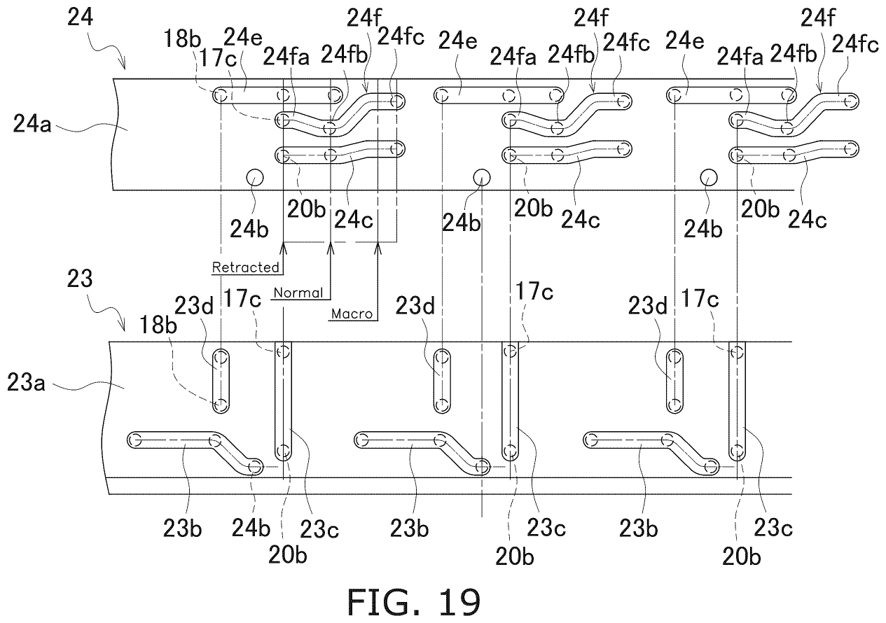

The correspondence between the cam grooves 24c, 24e, and 24f formed in the cam barrel 24 and the cam grooves 23b and the rectilinear grooves 23c and 23d provided to the fixed barrel 23 in a transition from the retracted state to the normal imaging state and the macro imaging state will be described with reference to FIG. 19.

### Retracted State

As shown in FIG. 19, in the retracted state, the cam pins 18b of the movable ring frame 18 are engaged with the cam grooves 24e provided to the cam barrel 24, and move in the circumferential direction relative to the cam barrel 24 as the switching ring 22 is turned to transition to the normal imaging state. At this point, the cam pins 18b of the movable ring frame 18 also engage with the rectilinear grooves 23d provided to the fixed barrel 23 disposed on the outer peripheral surface side of the cam barrel 24. This allows the movable ring frame 18 to be moved in the optical axis direction in synchronization with the cam barrel 24.

Also, as shown in FIG. 19, in the retracted state, the cam pins 17c of the cam pin frame 17 engage with the cam grooves 24f provided to the cam barrel 24, and move in the circumferential direction as the switching ring 22 is turned to transition to the normal imaging state. At this point, the cam pins 17c of the cam pin frame 17 also engage with the rectilinear grooves 23c provided to the fixed barrel 23 disposed on the outer peripheral surface side of the cam barrel 24. The cam pin frame 17 moves integrally with the distance scale ring 16 in the optical axis direction. This allows the cam pin frame 17 to be moved in the optical axis direction in synchronization with the distance scale ring 16.

As mentioned above, the cam grooves 24f are configured to include interference avoidance groove portions 24fb in order to prevent interference between the distance scale ring 16 and other components during transition between the retracted state and the normal imaging state.

Consequently, the switching ring 22 can be turned to switch between the retracted state and the normal imaging state while avoiding interference between the distance scale ring 16 and other components.

Furthermore, in the retracted state, as shown in FIG. 19, the cam pins 20b of the first lens frame 20 engage with the cam grooves 24c provided to the cam barrel 24, and move in the circumferential direction as the switching ring 22 is turned to transition to the normal imaging state.

Going from the retracted state to the normal imaging state, as shown in FIG. 19, the cam grooves 24c are formed linearly so as to be kept constant in the optical axis direction.

Also, in the retracted state, the cam pins 24b provided on the cam barrel 24 move in the circumferential direction in a state of being engaged with the cam grooves 23b provided to the fixed barrel 23.

### Normal Imaging State

As shown in FIG. 19, in the normal imaging state, the cam pins 18b of the movable ring frame 18 move to near the center of the cam grooves 24e provided to the cam barrel 24. At this point, since the cam grooves 24e are provided linearly along the circumferential direction (the direction perpendicular to the optical axis), the movable ring frame 18 does not move in the optical axis direction relative to the cam barrel 24.

Although the movable ring frame 18 does not move in the optical axis direction relative to the cam barrel 24, the cam barrel 24 does move in the optical axis direction, so the movable ring frame 18 moves in the optical axis direction by the amount of movement of the cam barrel 24.

As shown in FIG. 19, in the normal imaging state, the cam pins 17c of the cam pin frame 17 move circumferentially in a state of being engaged with the cam grooves 24f provided to the cam barrel 24, along with a transition to the normal imaging state when the switching ring 22 is turned. At this point, the cam pins 17c of the cam pin frame 17 move to the interference avoidance groove portions 24fb in the cam grooves 24f.

Consequently, when the switching ring 22 is turned, the distance scale ring 16 is temporarily retracted to the opposite side from the subject in the optical axis direction (the lower side in the drawing), which allows for a smooth transition between the retracted state and the normal imaging state while avoiding interference between the distance scale ring 16 and other components.

Furthermore, as shown in FIG. 19, in the normal imaging state, the cam pins 20b of the first lens frame 20 are engaged with the cam grooves 24c provided to the cam barrel 24, and move in the circumferential direction to near the center of the cam grooves 24c along with a transition to the normal imaging state when the switching ring 22 is turned. At this point, since the cam grooves 24c are provided linearly in the circumferential direction (the direction perpendicular to the optical axis) from the retracted state up until the normal imaging state, the first lens frame 20 does not move in the optical axis direction relative to the cam barrel 24.

Although the first lens frame 20 does not move in the optical axis direction relative to the cam barrel 24, the cam barrel 24 does move in the optical axis direction, and therefore the first lens frame 20 moves in the optical axis direction by the amount of movement of the cam barrel 24.

In the normal imaging state, cam pins 24b provided to the cam barrel 24 move in the circumferential direction from the right end to the left in the drawing, in a state of being engaged with cam grooves 23b provided to the fixed barrel 23. At this point, the cam grooves 23b are bent toward the subject side (the upper side in the drawing) in the optical axis direction from the retracted state up until the normal imaging state, as shown in FIG. 19.

Therefore, when the cam pins 24b engaged with the cam grooves 23b move in the circumferential direction, the cam barrel 24 and the movable ring frame 18, which is integrated with the cam barrel 24 in the optical axis direction, can be moved to the subject side (the upper side in the drawing).

### Macro Imaging State

In the macro imaging state, the cam pins 18b of the movable ring frame 18 move from near the center of the cam grooves 24e provided to the cam barrel 24, to near the right end in the drawing. At this point, since the cam grooves 24e are provided linearly in the circumferential direction (the direction perpendicular to the optical axis), the movable ring frame 18 does not move in the optical axis direction.

As shown in FIG. 19, in the macro imaging state, the cam pins 17c of the cam pin frame 17 move in the circumferential direction in a state of being engaged with the cam grooves 24f provided to the cam barrel 24, along with a transition to the macro imaging state when the switching ring 22 is turned. At this point, the cam pins 17c of the cam pin frame 17 move from the interference avoidance groove portions 24fb to the groove portions 24fc in the cam grooves 24f.

Consequently, a transition from the normal imaging state to the macro imaging state can be performed by turning the switching ring 22 and moving the distance scale ring 16 to the subject side in the optical axis direction.

Furthermore, as shown in FIG. 19, in the macro imaging state, the cam pins 20b of the first lens frame 20 are engaged with the cam grooves 24c provided to the cam barrel 24, and move in the circumferential direction from near the center of the cam grooves 24c to near the right end closer to the subject side as the switching ring 22 is turned to transition to the macro imaging state. At this point, since the cam grooves 24c are bent to the subject side in a transition from the normal state to the macro imaging state, the first lens frame 20 moves to the subject side in the optical axis direction.

Consequently, macro imaging can be performed by varying the distance between the first lens group L1 held by the first lens frame 20 and the second lens group L2.

Also, in the macro imaging state, the cam pins 24b on the cam barrel 24 move in the circumferential direction from near the center in the drawing to near the left end in a state of being engaged with the cam grooves 23b on the fixed barrel 23. At this point, the cam grooves 23b are provided linearly in the circumferential direction from the normal state up until the macro imaging state, as shown in FIG. 19. Therefore, the cam pins 24b engaged with the cam grooves 23b do not move in the circumferential direction, and there is no change in the position of the cam barrel 24 in the optical axis direction.

### Main Features

The lens barrel 10 of this embodiment is used in a state of being attached to an imaging device, and is provided with the substantially cylindrical fixed barrel 23, the first lens group L1, the first lens frame 20, the distance scale ring 16, and the switching ring 22. The first lens frame 20 holds the first lens group L1, is disposed on the inner diameter side of the fixed barrel 23, and is driven in the optical axis direction of the first lens group L1. The distance scale ring 16 is disposed at a position where at least a portion of it is exposed on the outer peripheral surface, and displays a normal imaging scale display 16b for normal imaging and a macro imaging scale display 16c for macro imaging. The switching ring 22 is rotatably disposed on the outer peripheral side of the fixed barrel 23, and is turned to switch between a retracted state (FIG. 2A) in which the normal imaging scale display 16b and the macro imaging scale display 16c are not displayed and the first lens frame 20 has moved to the opposite from the subject in the optical axis direction; a normal imaging state (FIG. 2B) in which only the normal imaging scale display 16b is displayed and the first lens frame 20 has moved to the subject side in the optical axis direction; and a macro imaging state (FIG. 2C) in which only the macro imaging scale display 16c is displayed and the first lens frame 20 has moved further to the subject side in the optical axis direction.

This allows different displays to be shown on the distance scale ring 16 depending on the imaging mode (the normal imaging mode or the macro imaging mode), and also reduces the size of the lens barrel in the optical axis direction when imaging is not in progress (in a retracted state).

### Embodiment 2

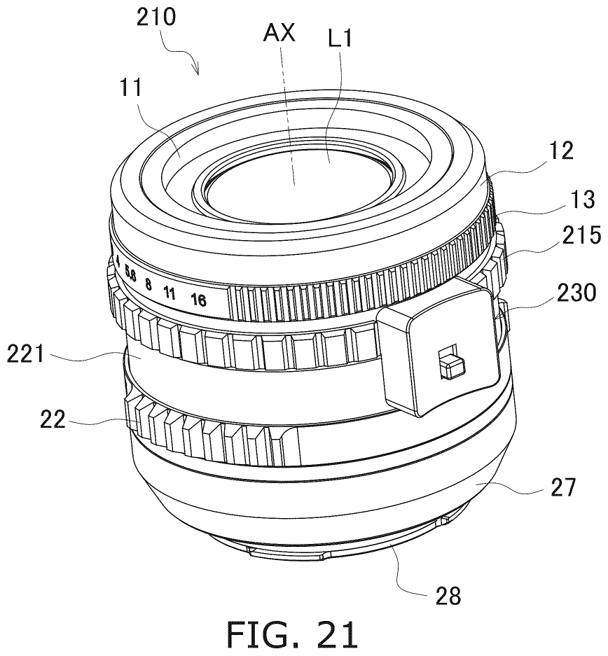

A lens barrel 210 according to yet another embodiment of the present disclosure will now be described with reference to FIGS. 21 to 38C.

The lens barrel 210 in this embodiment differs from the lens barrel 10 in the first embodiment in that a focus grip unit 230, which switches between autofocus mode (automatic mode) and manual focus mode (manual mode), is attached on the outer peripheral surface side of a focus ring 215.

However, other than the focus grip unit 230 and its surrounding components, the configuration is the same as that of the lens barrel 10 in embodiment 1 above, and therefore components having the same shape, function, etc., will be numbered the same and will not be described in detail again.

Lens barrels of recent years are provided with a switch for switching between autofocus mode and manual focus mode, and a focus ring for manually adjusting the focus in the manual focus mode.

In a configuration such as this, International Laid-Open Publication No. 2016/143327, for example, discloses a lens barrel in which a fixing unit for fixing a focus ring to a support frame when performing automatic focus adjustment has a fixing button that is operated when fixing the focus ring to the support frame, and the fixing button is disposed in an operating unit, in order to facilitate operation when switching between autofocus mode and manual focus mode.

However, because this lens barrel was configured not to transition to a retracted state, further improvement was needed to facilitate operation when switching between autofocus mode and manual focus mode in a lens barrel that does transition to a retracted state.

In view of this, it is an object of the lens barrel 210 of the present disclosure to provide a lens barrel that is able to transition to a retracted state, and which can improve operability when switching between autofocus mode and manual focus mode.

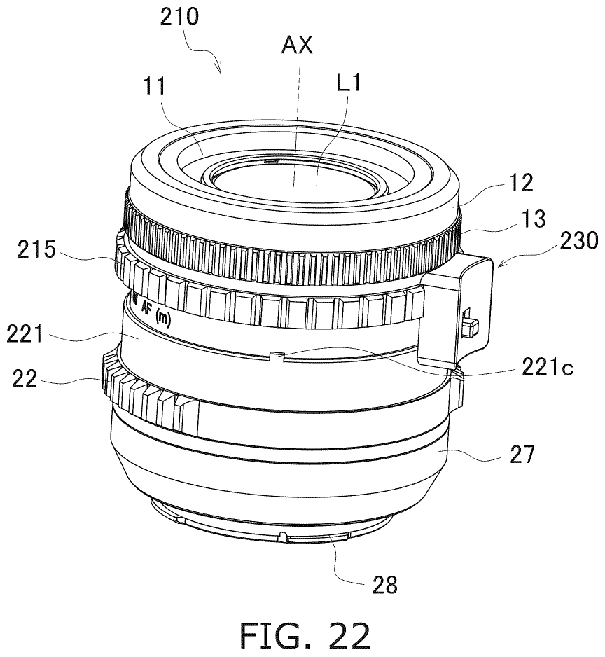

As shown in FIG. 21, the lens barrel 210 according to this embodiment is removably attached to a camera body (not shown), and images a subject. The built-in optical system of the lens barrel 210 moves in the optical axis direction between the retracted state shown in FIG. 21, the normal imaging state shown in FIG. 22, and a macro imaging state, and therefore performs normal imaging and macro (close-up) imaging while reducing the size of the lens barrel 210 in the optical axis direction when imaging is not in progress.

With the lens barrel 210 of this embodiment, as shown in FIGS. 21 and 22, the focus grip unit 230 is attached to the outer peripheral surface of the focus ring 215 in a state of being integrally rotatable along with the focus ring 215.

The focus grip unit 230 is provided to switch between a state in which switching between autofocus mode and manual focus mode is restricted (the ON state (first state)) and a state in which this restriction is removed (the OFF state (second state)).

That is, the focus grip unit 230 is fixed on the outer peripheral side of the focus ring 215 and switches between an ON state (first state), in which it is impossible to switch between manual (MF) mode in which focus adjustment is performed manually and autofocus (AF) mode in which focus adjustment of the focus ring 215 is performed automatically because contact is made with a portion of the depth scale ring 221, and an OFF state (second state), in which contact with a portion of the depth scale ring 221 is released and switching becomes possible between the AF mode and MF mode of the focus ring 215. The focus grip unit 230 disables switching between AF mode and MF mode in the retracted state in which the first lens frame 20 has moved to the opposite side from the subject in the optical axis AX direction.

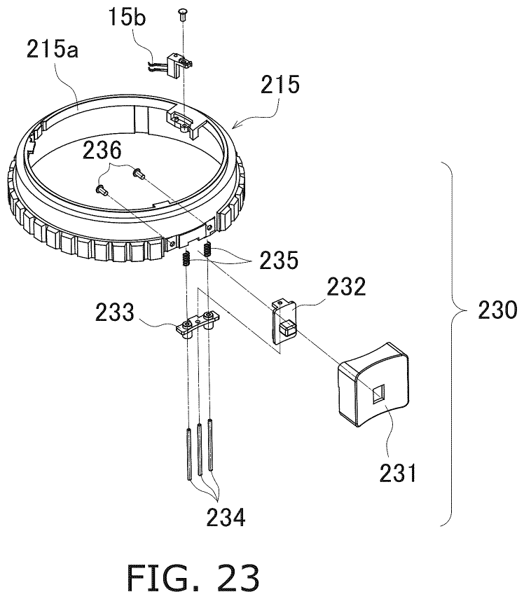

More precisely, as shown in FIG. 23, the focus grip unit 230 has a focus grip 231, a slide switch (switching operation unit) 232, a stopper (restriction unit) 233, a guide shaft 234, a spring (urging member) 235, and screws 236.

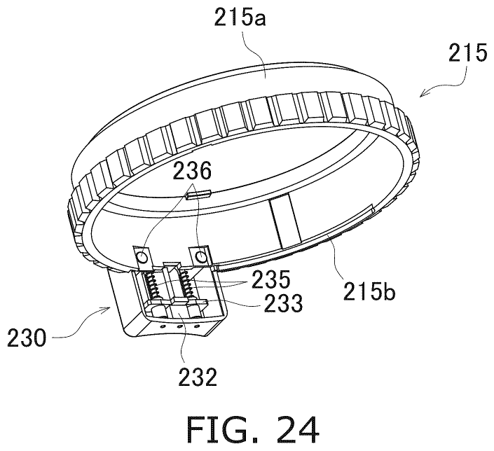

As shown in FIG. 24, the focus ring 215 to which the focus grip unit 230 is attached has a substantially cylindrical main body portion 215a and an escape groove (groove portion) 215b.

The escape groove (groove portion) 215b is a groove that accommodates the convex part 221c provided to the depth scale ring 221 when the focus ring 215 is in MF (manual focus) mode in the retracted state (discussed below), and is formed at the end on the inner peripheral surface side of the focus ring 215, on the image plane side in the optical axis AX direction.

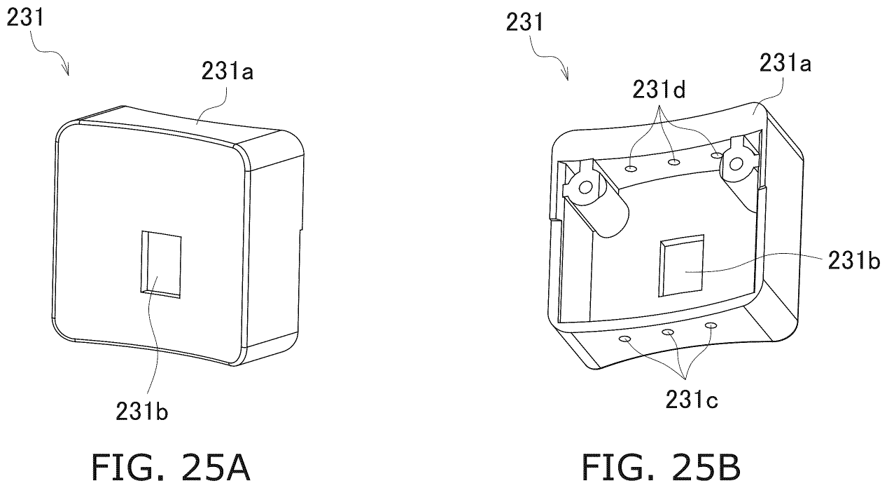

As shown in FIGS. 25A and 25B, the focus grip 231 has a housing 231a, an opening 231b, insertion holes 231c, and press-fit holes 231d.

The housing 231a is a box-shaped member that is held by the user who turns the focus ring 215, and is fixed to the focus ring 215 by the two screws 236 shown in FIG. 23.

The opening 231b is an oblong hole provided in the optical axis AX direction in the front part of the box-shaped focus grip 231, and is disposed in a state of being movable in the optical axis AX direction when the operating knob 232a of the slide switch 232 has been inserted.

The insertion holes 231c are three through-holes formed in the surface of the housing 231a that intersects the optical axis AX, and three guide shafts 234 are inserted into the insertion holes 231c, respectively.

The press-fit holes 231d are three blind holes formed in the surface of the housing 231a opposite the surface in which the insertion holes 231c are formed, and hold one end of the guide shafts 234. Consequently, the stopper 233 moves along the guide shafts 234 in a state in which the three guide shafts 234 are held inside the housing 231a.

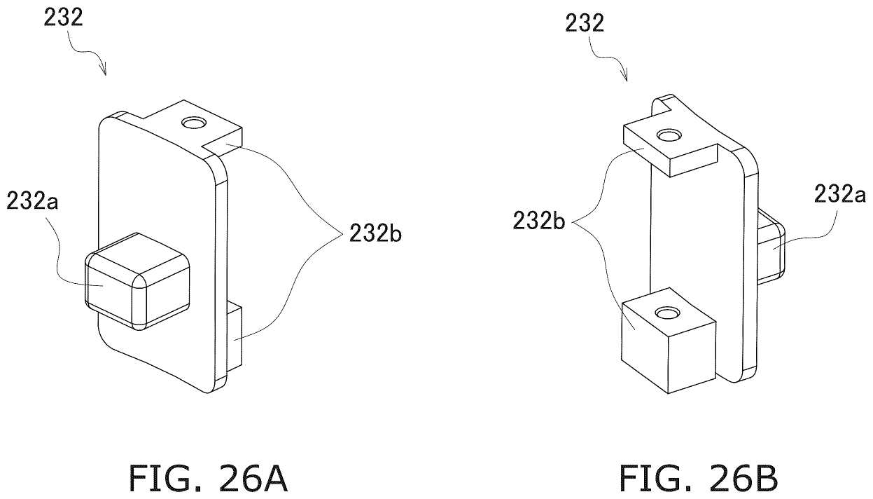

The slide switch (switching operation unit) 232 is operated by the user when switching between the ON and OFF states of the focus grip unit 230. More specifically, when transitioning from an ON state to an OFF state, for example, the slide switch 232 is operated so as to move the stopper 233 in the opposite direction from the direction of making contact with the convex part 221c. As shown in FIGS. 26A and 26B, the slide switch 232 includes an operation knob 232a and a bearing portion 232b into which one of the three guide shafts 234 is inserted.

The operation knob 232a is disposed so as to be exposed to the outside from the opening 231b of the housing 231a, and is operated by the user.

The middle of the three guide shafts 234 is inserted into the bearing portion 232b. This allows the slide switch 232 to move along the guide shafts 234.

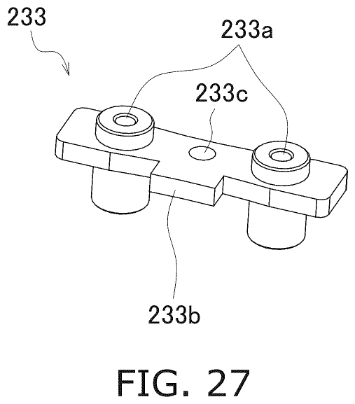

The stopper (restriction unit) 233 is a member that moves in conjunction with the slide switch 232, and is biased in the optical axis AX direction by a spring 235 (discussed below). As shown in FIG. 27, the stopper 233 includes bearing portions 233a and a protrusion 233b.

Two of the three guide shafts 234 (the ones on both sides) are inserted into the bearing portions 233a. This allows the stopper 233 to move along the guide shafts 234 in conjunction with the operation of the slide switch 232.

The protrusion 233b is a portion that protrudes in a direction intersecting the optical axis AX direction, and when the focus grip unit 230 is in the ON state, it makes contact with a convex part 221c provided so as to protrude from the end surface 221b of the depth scale ring 221.

Consequently, the focus ring 215 to which the focus grip unit 230 is fixed is restricted from moving in the rotational direction, and switching between AF mode and MF mode is disabled.

More precisely, the depth scale ring 221 with which the protrusion 233b makes contact has a substantially cylindrical main body portion 221a, an end surface 221b that intersects the optical axis AX direction, and a convex part 221c that protrudes from the end surface 221b in the optical axis AX direction.

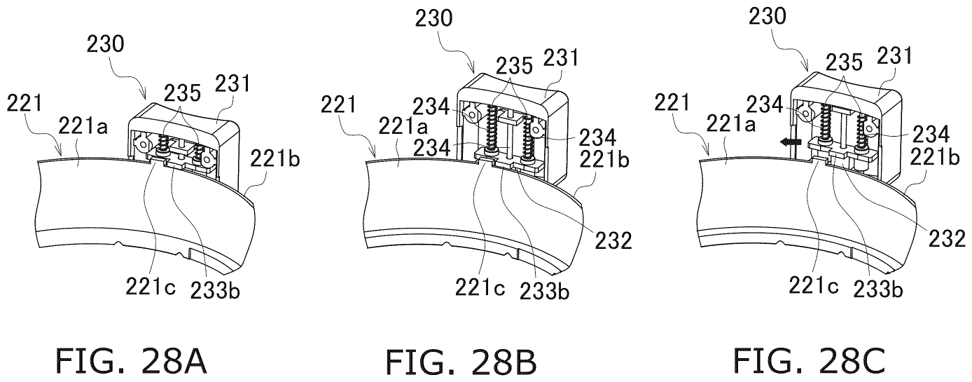

As shown in FIG. 28A, etc., the convex part 221c protrudes in the optical axis AX direction, and in this state the protrusion 233b of the stopper 233 makes contact with the side surface of the convex part 221c.

Consequently, in the ON state, the stopper 233 makes contact with the convex part 221c in the rotational direction, preventing the focus ring 215 from rotating, and in the OFF state, its contact with the convex part 221c in the rotational direction is released, allowing the focus ring 215 to rotate.

The three guide shafts 234 are disposed parallel to each other in the optical axis AX direction so as to be enveloped by the housing 231a of the focus grip 231. The two guide shafts 234 on both sides are inserted into the bearing portions 233a of the stopper 233, and guide the movement of the stopper 233 in the optical axis AX direction. The middle guide shaft 234 is inserted into a through-hole 233c formed in the stopper 233 and the bearing portion 232b of the slide switch 232, and guides the movement of the stopper 233 in the optical axis AX direction.

The spring (biasing member) 235 is provided so as to wrap around the two of the three guide shafts 234 that are on the sides, and biases the stopper 233 in the optical axis AX direction (the direction in which the slide switch 232 is operated). More precisely, the spring 235 biases the stopper 233 toward the position of making contact with the convex part 221c.

The screws 236 are threaded into screw holes provided to the focus grip 231 from the inner peripheral surface side of the focus ring 215, to fix the focus grip unit 230 to the focus ring 215.

### Contact and Release Between Protrusion 233b and Convex Part 221c

With the lens barrel 210 of this embodiment, the positional relationship between the protrusion 233b of the stopper 233 and the convex part 221c of the depth scale ring 221 changes depending on whether the lens barrel 210 is in its retracted state (see FIG. 28A), an ON state (see FIG. 28B) of the focus grip unit 230 during normal use (normal imaging, macro imaging), or an OFF state (see FIG. 28C), thereby switching between a state in which AF mode and MF mode can be switched and a state in which they cannot be switched.

More specifically, in the retracted state in AF mode shown in FIG. 28A, the stopper 233 is biased by the spring 235 so as to be pressed against the end surface 221b of the depth scale ring 221 in the optical axis AX direction. The protrusion 233b of the stopper 233 is also in contact with the side surface of the convex part 221c of the depth scale ring 221 in the rotational direction, so it is not possible to switch from AF mode to MF mode by turning the focus ring 215 to which the focus grip unit 230 is fixed.

When the slide switch 232 is in the ON state in AF mode during normal use as shown in FIG. 28B, the stopper 233 is biased by the spring 235 against the slide switch 232 in the optical axis AX direction. At this point, the stopper 233 makes contact with the bearing portion 232b of the slide switch 232 in the optical axis AX direction, and is in a location slightly away from the end surface 221b of the depth scale ring 221.

This makes it easier to operate the slide switch 232, which is in direct contact with the stopper 233, and also makes it less likely that there will be friction, etc., since the focus ring 215 does not come into contact with the end surface 221b of the depth scale ring 221 when rotating in MF mode.

Since the protrusion 233b of the stopper 233 is in contact with the side of the convex part 221c of the depth scale ring 221 in the rotational direction, the focus ring 215 to which the focus grip unit 230 is fixed cannot be turned to switch from AF mode to MF mode.

Next, in a state in which the slide switch 232 is OFF in the AF mode during normal use as shown in FIG. 28C, the stopper 233 moves to a position that is offset from the convex part 221c in the optical axis AX direction when the slide switch 232 is operated.

Consequently, the protrusion 233b of the stopper 233 is released from being in contact with the convex part 221c of the depth scale ring 221 in the rotational direction, so the focus ring 215 to which the focus grip unit 230 is fixed can be turned in the direction of the arrow in the drawing to switch from AF mode to MF mode.

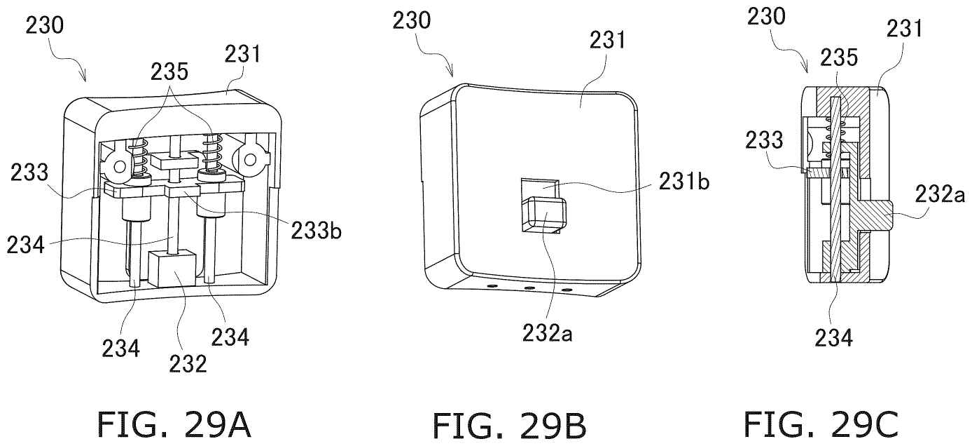

The retracted state shown in FIG. 28A will now be described in further detail with reference to FIGS. 29A, 29B, and 29C.

When the lens barrel 210 transitions to its retracted state, the focus ring 215 moves to the image plane side in the optical axis AX direction, and which is accompanied by movement of the focus grip unit 230 to the image plane side.

As shown in FIG. 29A, the stopper 233 moves in the direction (upward in the drawing) of compressing the spring 235. At this point, as shown in FIGS. 29B and 29C, no biasing force is imparted to the slide switch 232 by the spring 235, and the slide switch 232 is in the lowest position in the drawing.

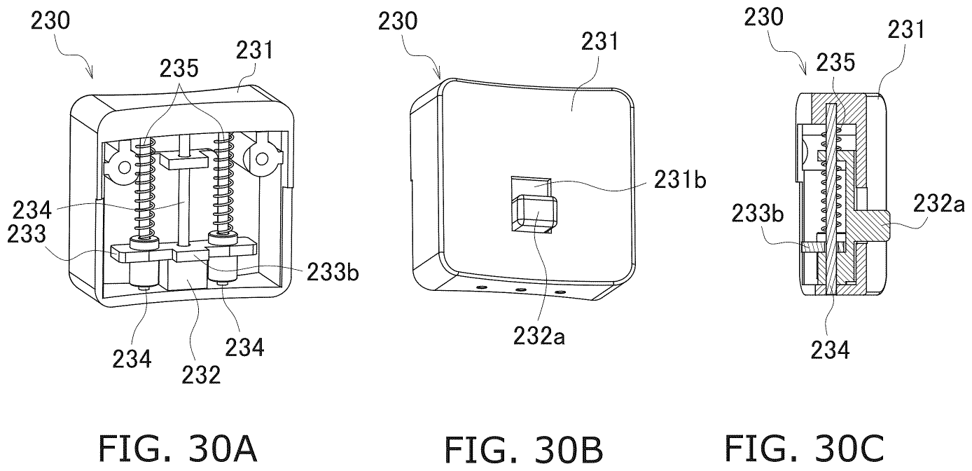

Next, the ON state of the slide switch 232 shown in FIG. 28B will be described in further detail with reference to FIGS. 30A, 30B, and 30C.

During normal use (normal imaging or macro imaging), when the slide switch 232 is operated to transition to the ON state, the stopper 233 is subjected to the biasing force of spring 235 and makes contact with the bearing portion 232b of the slide switch 232, as shown in FIG. 30A. At this point, as shown in FIGS. 30B and 30C, the biasing force of the spring 235 is applied to the slide switch 232 via the stopper 233, and the slide switch 232 is biased downward in the drawing.

Consequently, as mentioned above, the stopper 233 comes into contact with the side surface of the convex part 221c of the depth scale ring 221, and it is impossible to switch from the AF mode to the MF mode.

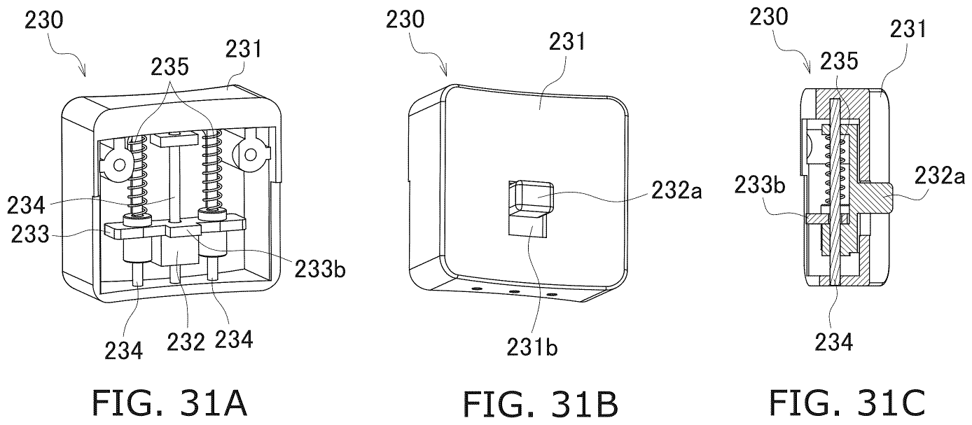

Next, the OFF state of the slide switch 232 shown in FIG. 28C will be described in further detail with reference to FIGS. 31A, 31B, and 31C.

During normal use (normal imaging or macro imaging), when the slide switch 232 is operated to transition from the ON state to the OFF state, the stopper 233 moves in the direction of going against the biasing force of the spring 235 as the slide switch 232 moves upward in the drawing, as shown in FIG. 31A. At this point, as shown in FIGS. 31B and 31C, the biasing force of the spring 235 is applied to the slide switch 232 via the stopper 233, and the slide switch 232 is biased downward in the drawing. Therefore, when the user releases the operation, the biasing force of the spring 235 returns the slide switch 232 and the stopper 233 to their ON state positions.

Consequently, as mentioned above, the stopper 233 moves to a position that is offset in the optical axis AX direction relative to the convex part 221c of the depth scale ring 221, so the stopper 233 is released from being in contact with the side surface, which allows switching from AF mode to MF mode.

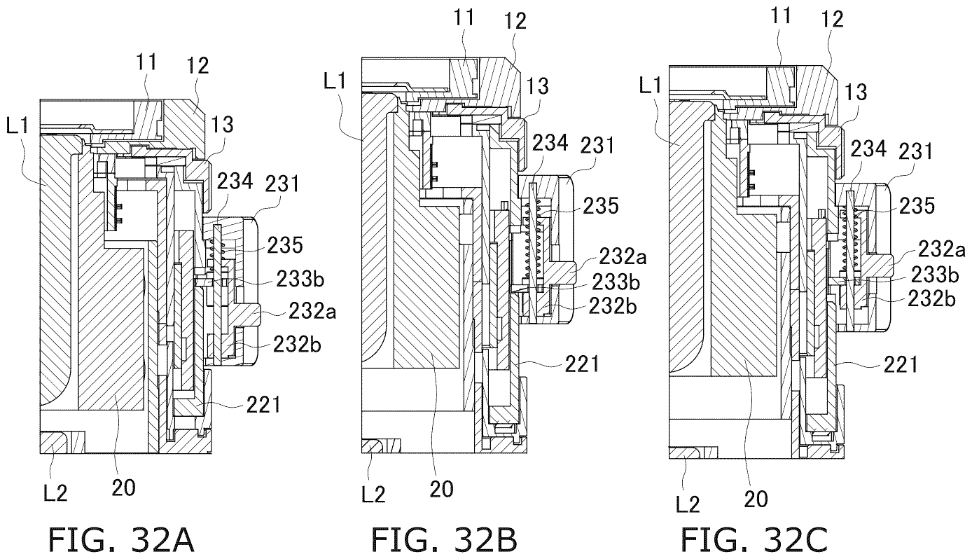

That is, when the lens barrel 210 is in its retracted state, as shown in FIG. 32A, the stopper 233 moves away from the slide switch 232 and is subjected to a biasing force from the spring 235, thereby coming into contact with the end surface 221b of the depth scale ring 221.

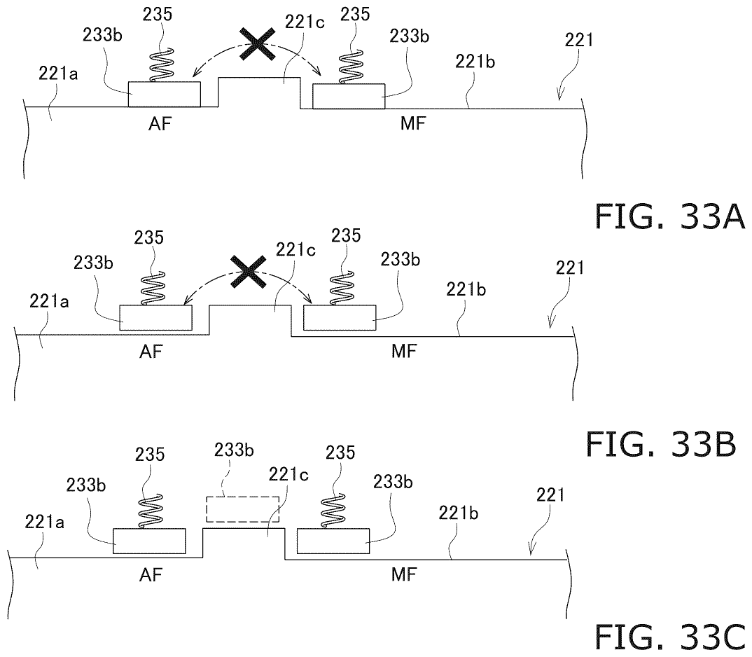

Consequently, in the retracted state, the protrusion 233b of the stopper 233 is in contact with the end surface 221b of the depth scale ring 221, with no gap in between, due to the biasing force of the spring 235, as shown in FIG. 33A. At this point, the stopper 233 is not in contact with the bearing portion 232b of the slide switch 232 and cannot be operated by the slide switch 232. Accordingly, the protrusion 233b of the stopper 233 cannot move up and over the convex part 221c, so switching between AF mode and MF mode is impossible. This means that when the focus ring 215 is in AF mode, it remains in AF mode, and when it is in MF mode, it remains in MF mode.

Next, when the lens barrel 210 is in normal use and the slide switch 232 is in the ON state, the stopper 233 is subjected to a biasing force from the spring 235 and comes into contact with the bearing portion 232b of the slide switch 232, as shown in FIG. 32B.

Consequently, in the ON state during normal use, as shown in FIG. 33B, the protrusion 233b of the stopper 233 is in contact with the bearing portion 232b of the slide switch 232 due to the biasing force of the spring 235, in a state in which there is a gap between the protrusion 233b and the end surface 221b of the depth scale ring 221. Therefore, unless the slide switch 232 is operated, the protrusion 233b of the stopper 233 cannot move up and over the convex part 221c, so switching between AF mode and MF mode is impossible. Therefore, just as in the retracted state, when the focus ring 215 is in AF mode, it remains in AF mode, and when it is in MF mode, it remains in MF mode.

Meanwhile, when the lens barrel 210 is in normal use and the slide switch 232 is operated to the OFF state, the stopper 233 moves in a direction that goes against the biasing force from the spring 235 as the slide switch 232 moves, as shown in FIG. 32C.

Consequently, in the OFF state during normal use, the protrusion 233b of the stopper 233 moves to a position that is offset from the convex part 221c in the optical axis AX direction. At this point, as shown in FIG. 33C, the protrusion 233b of the stopper 233 is in contact with the bearing portion 232b of the slide switch 232 due to the biasing force of the spring 235, with a gap between the protrusion 233b and the end surface 221b of the depth scale ring 221, so the protrusion 233b can move up and over the convex part 221c when the slide switch 232 is operated to the OFF position, making it possible to switch between AF mode and MF mode.

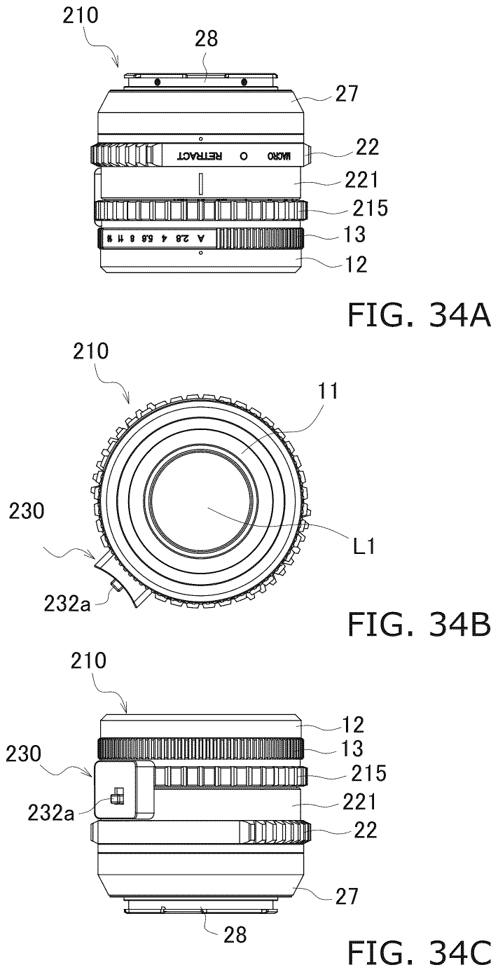

The changes in the appearance of the lens barrel 210 when in its retracted state, normal imaging state (AF mode or MF mode), and macro imaging state (AF mode or MF mode) will now be described with reference to FIGS. 34A to 38C.

In the retracted state, as shown in FIG. 34A, the size of the lens barrel 210 in the optical axis AX direction is minimized, unlike during normal use, and the normal imaging scale display 16b and the macro imaging scale display 16c of the distance scale ring 16 described in Embodiment 1 are not displayed.

In this retracted state, when the focus grip unit 230 is mounted as shown in FIG. 34B, the convex part 221c of the depth scale ring 221 is held within the escape groove 215b provided in the focus ring 215, as shown in FIG. 34C, and is invisible from the outside.

In the retracted state, in MF mode, the focus ring 215 can be turned within the MF mode range. At this time, the convex part 221c of the depth scale ring 221 moves within the escape groove 215b provided in the focus ring 215.

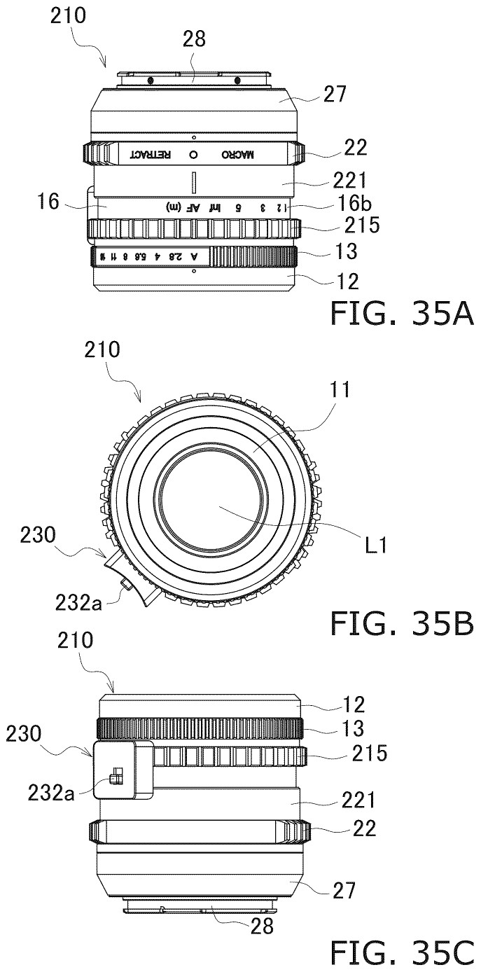

Next, in AF mode in the normal imaging state, as shown in FIG. 35A, compared to the retracted state, the lens group of the lens barrel 210 advances to the subject side in the optical axis AX direction, the size in the optical axis AX direction increases, and the normal imaging scale display 16b of the distance scale ring 16 described in Embodiment 1 is displayed.

In this state, when the focus grip unit 230 is mounted as shown in FIG. 35B, the convex part 221c of the depth scale ring 221 is positioned on the inner peripheral side of the focus grip unit 230 as shown in FIG. 35C, and movement in the rotational direction is restricted by the stopper 233.

Consequently, up until the slide switch 232 is operated to transition from the ON state to the OFF state, turning of the focus ring 215 is restricted by the contact between the convex part 221c and the stopper 233, making it impossible to switch from AF mode to MF mode.

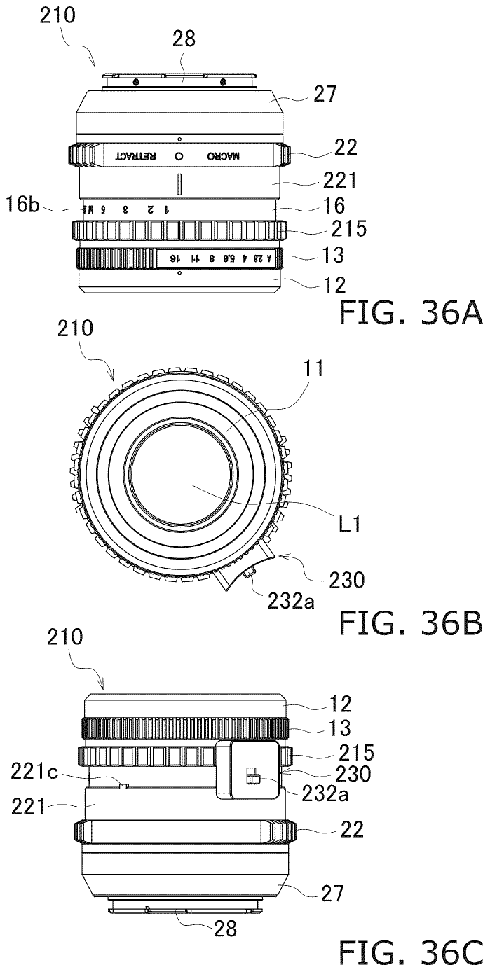

Next, in MF mode in the normal imaging state, as shown in FIG. 36A, compared to the retracted state, the lens group of lens barrel 210 advances to the subject side in the direction of optical axis AX, the size in the direction of optical axis AX increases, and the normal imaging scale display 16b of the distance scale ring 16 described in Embodiment 1 is displayed.

In this state, when the focus grip unit 230 is mounted as shown in FIG. 36B, the convex part 221c of the depth scale ring 221 is exposed at a position that is offset in the circumferential direction from the focus grip unit 230, as shown in FIG. 36C.

Consequently, although the focus ring 215 can be turned within the range of MF mode up until the slide switch 232 is operated to transition from the ON state to the OFF state, the turning of the focus ring 215 is restricted by contact between the convex part 221c and the stopper 233, making it impossible to switch from MF mode to AF mode.

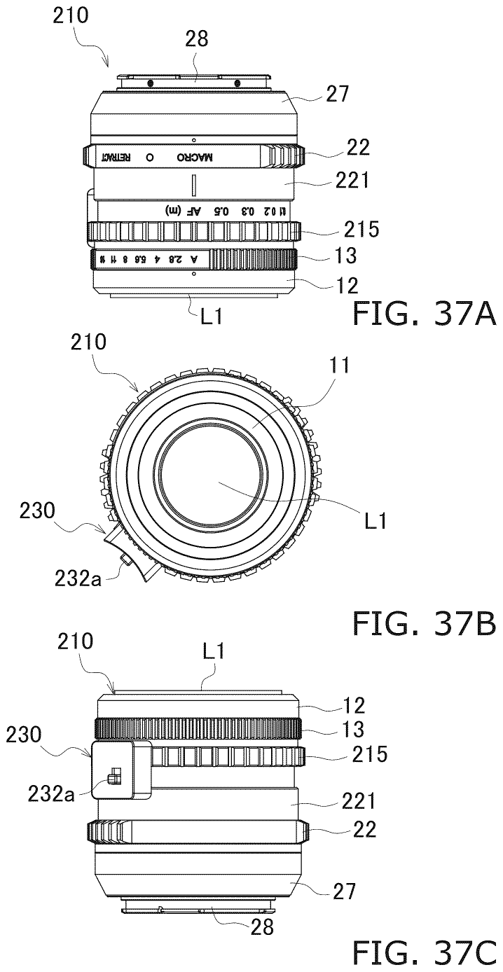

Next, in AF mode in the macro imaging state, as shown in FIG. 37A, compared to the normal imaging state, the first lens frame 20 including the first lens group L1 of the lens barrel 210 advances to the subject side in the optical axis AX direction.

In this state, when the focus grip unit 230 is mounted as shown in FIG. 37B, the convex part 221c of the depth scale ring 221 is positioned on the inner peripheral side of the focus grip unit 230 as shown in FIG. 37C, and movement in the rotational direction is restricted by the stopper 233.

Consequently, up until the slide switch 232 is operated to change from the ON state to the OFF state, the turning of the focus ring 215 is restricted by contact between the convex part 221c and the stopper 233, making it impossible to switch from AF mode to MF mode.

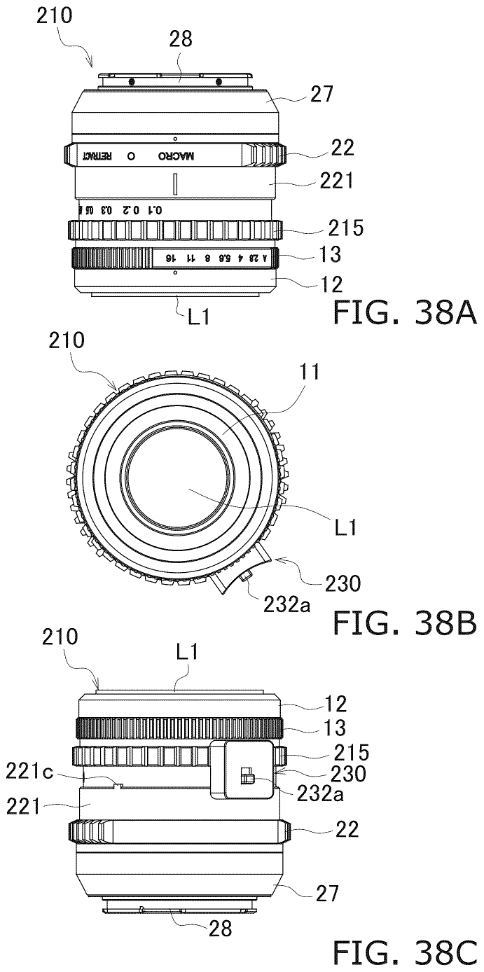

Next, in MF mode in the macro imaging state, as shown in FIG. 38A, compared to the normal imaging state, the first lens frame 20 including the first lens group L1 of the lens barrel 210 advances to the subject side in the optical axis AX direction.

In this state, when the focus grip unit 230 is mounted as shown in FIG. 38B, the convex part 221c of the depth scale ring 221 is exposed at a position that is offset in the circumferential direction from the focus grip unit 230, as shown in FIG. 38C.

Consequently, although the focus ring 215 can be turned within the range of MF mode up until the slide switch 232 is operated to transition from the ON state to the OFF state, the turning of the focus ring 215 is restricted by contact between the convex part 221c and the stopper 233, making it impossible to switch from MF mode to AF mode.

### Main Components

The lens barrel 210 in this embodiment is a lens barrel that is used while attached to an imaging device, and includes the substantially cylindrical fixed barrel 23, the lens group L1, the first lens frame 20, the focus ring 215, the substantially cylindrical depth scale ring 221, and the focus grip unit 230. The first lens frame 20 holds the lens group L1, is disposed on the inner diameter side of the fixed barrel 23, and is driven in the optical axis AX direction of the lens group L1. The focus ring 215 is provided on the outer peripheral side of the fixed barrel 23, and is turned around the optical axis AX of the lens group L1 relative to the fixed barrel 23 during manual adjustment of the focus. The substantially cylindrical depth scale ring 221 is provided on the outer peripheral side of the fixed barrel 23. The focus grip unit 230 is fixed on the outer peripheral side of the focus ring 215, and switches between an ON state, in which contact is made with part of the depth scale ring 221 to disable switching between AF (automatic) mode, in which focus adjustment of the focus ring 215 is performed automatically, and MF (manual) mode, in which focus adjustment is performed manually, and an OFF state, in which the contact with part of the depth scale ring 221 is released to enable switching between AF mode and MF mode of the focus ring 215. The focus grip unit 230 has the stopper 233 that disables switching between AF mode and MF mode in the retracted state in which the first lens frame 20 has moved to the opposite side from the subject in the optical axis AX direction.

This improves the operability when switching between AF (autofocus) mode and MF (manual focus) mode in the lens barrel 210 in a transition to its retracted state.

### Other Embodiments

An embodiment of the present disclosure was described above, but the present disclosure is not limited to or by the above embodiment, and various modifications are possible without departing from the gist of the disclosure.

### (A)

In the above embodiment, an example was given in which the distance scale ring 16, on the outer surface of which was displayed the normal imaging scale display 16b and the macro imaging scale display 16c, was used as a display unit for displaying a first display and a second display that was different from the first display. However, the present disclosure is not limited to this.

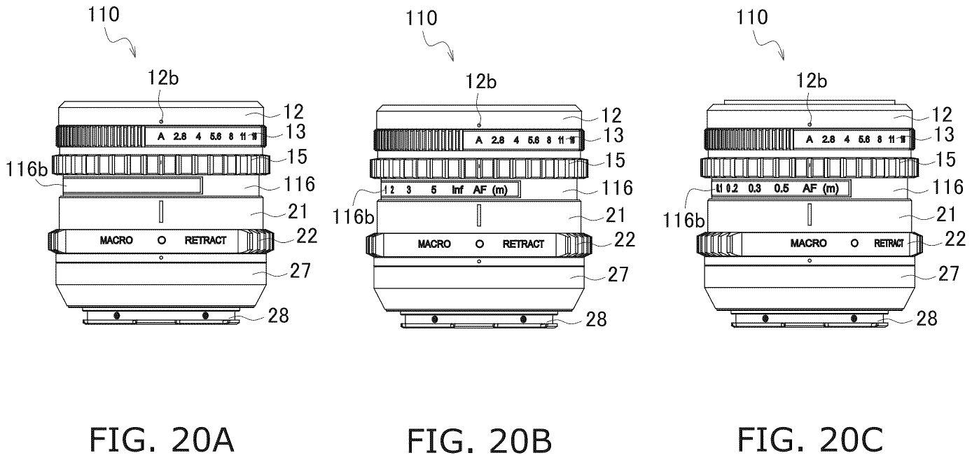

For example, as shown in FIGS. 20A, 20B, and 20C, the lens barrel 110 may be provided with a distance scale ring 116 having a display panel 116b that can switch between displaying nothing, displaying a scale for normal imaging, and displaying a scale for macro imaging.

The display panel 116b is provided on the outer peripheral surface of the main body portion (display main body portion) 116a, and when not imaging as shown in FIG. 20A, the distance scale display is hidden, during normal imaging as shown in FIG. 20B, the scale display for normal imaging is displayed, and during macro imaging as shown in FIG. 20C, the scale display for macro imaging is displayed.

This affords the same effect as in the above embodiment.

### (B)

In the above embodiment, an example was given in which the distance scale ring 16, on the outer surface of which was displayed the normal imaging scale display 16b and the macro imaging scale display 16c, was used as a display unit for displaying a first display and a second display that was different from the first display. However, the present disclosure is not limited to this.

For example, instead of displaying a distance scale matching the imaging mode as the first and second displays, the configuration may be such that other displays are given, such as an aperture value, an F-number, etc.

### (C)

In the above embodiment, an example was given in which the protrusions 16d for synchronizing the rotation of the focus ring 15 and the distance scale ring 16 were provided at four locations around the outer peripheral surface of the substantially annular main body portion 15a, but the present disclosure is not limited to this.

For example, one or more protrusions for synchronizing the rotation of the focus ring and the distance scale ring may be provided on the outer peripheral surface of the substantially annular main body portion.

### (D)

In the above embodiment, an example was given in which two lens groups were included, namely, the first lens group L1 and the second lens group L2. However, the present disclosure is not limited to this.

For example, the configuration of the present disclosure may be applied to a lens barrel including three or more lens groups.

### (E)

In the above embodiment, an example was given in which the configuration of the present disclosure was applied to the lens barrel 10 that was removably attached to a camera body (not shown). However, the present disclosure is not limited to this.

For example, the configuration of the present disclosure may be applied to a lens barrel that is permanently attached to a camera body.

### Addenda

The above description of the embodiments discloses the following techniques.

### Technique 1

The lens barrel according to Technique 1 is used in a state of having been attached to an imaging device, the lens barrel comprising:

a substantially cylindrical fixed barrel;

a lens group;

a lens frame that holds the lens group, is disposed on an inner diameter side of the fixed barrel, and is configured to be driven in an optical axis direction of the lens group;

a display unit that is disposed at a position at which at least a portion thereof is exposed on an outer peripheral surface, and that is configured to display a first display and a second display different from the first display; and

a switching ring that is rotatably disposed on an outer peripheral side of the fixed barrel and that is configured to switch by a rotation operation between a retracted state in which neither the first display nor the second display is displayed and the lens frame has moved to an opposite side from a subject in the optical axis direction, a normal imaging state in which only the first display is displayed and the lens frame has moved toward a subject side in the optical axis direction, and a macro imaging state in which only the second display is displayed and the lens frame has moved further toward the subject side in the optical axis direction.

### Technique 2

The lens barrel according to Technique 2 is the lens barrel according to Technique 1,

wherein the display unit further has a substantially cylindrical display main body portion disposed on the inner diameter side of the fixed barrel, and

the first display is provided on the outer peripheral surface of the display main body portion, and the second display is provided at a position adjacent to the first display on the display main body portion in the optical axis direction.

### Technique 3

The lens barrel according to Technique 3 is the lens barrel according to Technique 1,

wherein the display unit has a display panel configured to switch between non-display, the first display, and the second display in response to the turning of the switching ring.

### Technique 4

The lens barrel according to Technique 4 is the lens barrel according to Technique 2,

wherein the display unit moves back and forth in the optical axis direction in conjunction with the transition to the retracted state, the normal imaging state, and the macro imaging state, which are switched in response to the turning of the switching ring.

### Technique 5

The lens barrel according to Technique 5 is the lens barrel according to any one of Techniques 1 to 4,

further comprising a cam barrel having a substantially cylindrical cam body portion and a first cam pin that is provided so as to protrude in a radial direction from the cam body portion,

wherein the fixed barrel further has a first cam groove in which the first cam pin moves in a state of being engaged in a transition from the retracted state to the normal imaging state.

### Technique 6

The lens barrel according to Technique 6 is the lens barrel according to Technique 5,

wherein the lens frame has a substantially cylindrical lens frame main body portion and a second cam pin that is provided so as to protrude in the radial direction from the lens frame main body, and

the cam barrel further has a second cam groove that is provided to the cam main body portion, and in which the second cam pin moves in a state of being engaged in a transition from the normal imaging state to the macro imaging state.

### Technique 7

The lens barrel according to Technique 7 is the lens barrel according to Technique 2,

wherein the lens frame has a substantially cylindrical lens frame main body portion and a second cam pin that is provided so as to protrude in a radial direction from the lens frame main body portion,

there is further provided a cam pin frame having a substantially cylindrical cam pin frame main body portion rotatably provided on an inner peripheral surface side of the substantially cylindrical display main body portion, and a third cam pin provided so as to protrude in the radial direction from the cam pin frame main body portion, and

the fixed barrel has a first rectilinear groove that runs in the optical axis direction and in which the second cam pin and the third cam pin move in a state of being engaged.

### Technique 8

The lens barrel according to Technique 8 is the lens barrel according to Technique 4,

wherein the display unit further has a slide groove provided running linearly along a circumferential direction on a side of the inner peripheral surface of the display main body portion, and

there is further provided a cam pin frame having a substantially cylindrical cam pin frame main body portion rotatably provided on an inner peripheral surface side of the substantially cylindrical display main body portion, and a protrusion portion that is provided so as to protrude outward in a radial direction from the cam pin frame main body portion and moves in the circumferential direction along the slide groove.

### Technique 9

The lens barrel according to Technique 9 is the lens barrel according to Technique 8,

wherein the cam pin frame further has a third cam pin provided so as to protrude in the radial direction from the cam pin frame main body portion, and

there is further provided a cam barrel having a display switching cam groove configured to move the cam pin frame, with which the display unit is integrated in the optical axis direction, back and forth in the optical axis direction when the third cam pin is moved in an engaged state by turning the switching ring.

### Technique 10

The lens barrel according to Technique 10 is the lens barrel according to Technique 9,

wherein the display switching cam groove has a first groove portion that is provided along the circumferential direction and in which the third cam pin of the cam pin frame is positioned in the retracted state, an interference avoidance groove portion configured to guide the third cam pin to the opposite side from the subject when a state is transferred from the retracted state to the normal imaging state and the display unit is moved toward the subject side in the optical axis direction, and a second groove portion configured to guide the third cam pin toward the subject side when a state is transferred from the normal imaging state to the macro imaging state and the display unit is moved further toward the subject side in the optical axis direction.

### Technique 11

The lens barrel according to Technique 11 is the lens barrel according to any of Techniques 1 to 10,

further comprising a movable frame having a substantially cylindrical movable main body portion and a fourth cam pin provided so as to protrude in the radial direction from the movable main body portion,

wherein the fixed barrel further has a substantially cylindrical fixed main body portion and a second rectilinear groove that is provided along the optical axis direction and in which the fourth cam pin provided to the movable frame moves in a state of being engaged.

### Technique 12

The lens barrel according to Technique 12 is the lens barrel according to Technique 11,

further comprising a cam barrel having a substantially cylindrical cam main body portion and a synchronous cam groove that is provided along the circumferential direction and moves the movable frame synchronously in the optical axis direction when the fourth cam pin moves in a state of being engaged.

### Technique 13

The lens barrel according to Technique 13 is the lens barrel according to any of Techniques 1 to 12,

wherein the first display is a scale display including a first distance, the aperture, or the F-number, and is displayed in the normal imaging state.

### Technique 14

The lens barrel according to Technique 14 is the lens barrel according to any of Techniques 1 to 13,

wherein the second display is a scale display including a second distance, the aperture, or the F-number, and is displayed in the macro imaging state.

### Technique 15

The lens barrel according to Technique 15 is:

a lens barrel used in a state of being attached to an imaging device, comprising:

a substantially cylindrical fixed barrel;

a lens group;

a lens frame that holds the lens group, is disposed on the inner diameter side of the fixed barrel, and is driven in the optical axis direction of the lens group;

a focus ring that is provided on the outer peripheral side of the fixed barrel and is rotated around the optical axis of the lens group relative to the fixed barrel when the focus is adjusted manually;

a substantially cylindrical barrel member that is provided on the outer peripheral side of the fixed barrel; and

a rotation restriction switching unit that is fixed on the outer peripheral side of the focus ring, switches between a first state in which contact with a part of the barrel member prevents switching between an automatic mode that automatically performs focus adjustment of the focus ring and a manual mode that performs the focus adjustment manually, and a second state in which the contact with a part of the barrel member is released, allowing switching of the focus ring between the automatic mode and the manual mode, and has a restriction unit that disables switching between the automatic mode and the manual mode in a retracted state in which the lens frame has moved to the opposite side from the subject in the optical axis direction.

### Technique 16

The lens barrel according to Technique 16 is the lens barrel according to Technique 15,

wherein the barrel member has an end surface that intersects the optical axis direction, and a convex part that protrudes from the end surface in the optical axis direction, and

the restriction unit, in the first state, comes into contact with the convex part in the rotational direction to restrict rotation of the focus ring, and in the second state, the contact with the convex part in the rotational direction is released, allowing the focus ring to rotate.

### Technique 17

The lens barrel according to Technique 17 is the lens barrel according to Technique 16,

wherein the rotation restriction switching unit further has a biasing member that biases the restriction unit toward a position of coming into contact with the convex part, and a switching operation unit that is operated so as to move the restriction unit in the direction opposite from a direction in which the restriction unit makes contact with the convex part in a transition from the first state to the second state.

### Technique 18

The lens barrel according to Technique 18 is the lens barrel according to Technique 17,

wherein in the first state, the restriction unit does not make contact with the end surface of the barrel member in the optical axis direction, and instead makes contact with a part of the switching operation unit.

### Technique 19

The lens barrel according to Technique 19 is the lens barrel according to Technique 17 or 18,

wherein in the retracted state, the restriction unit makes contact with the end surface of the barrel member and does not make contact with a part of the switching operation unit.

### Technique 20

The lens barrel according to Technique 20 is the lens barrel according to any of Techniques 16 to 18,

wherein the biasing member biases the restriction unit in the optical axis direction.

### Technique 21

The lens barrel according to Technique 21 is the lens barrel according to Technique 17 or 18,

wherein the rotation restriction switching unit further has a guide shaft that is disposed along the optical axis direction, and

the switching operation unit is operated so as to slide along the guide shaft in the optical axis direction.

### Technique 22

The lens barrel according to Technique 22 is the lens barrel according to any of Techniques 16 to 20,

wherein the focus ring has a groove portion that, in the retracted state, accommodates the convex part of the barrel member on the inner peripheral surface side.

### Technique 23

The lens barrel according to Technique 23 is the lens barrel according to any of Techniques 16 to 20,

wherein, in the retracted state, the restriction unit (stopper) makes contact with the end surface of the barrel member, making it impossible to switch between the automatic mode and the manual mode.

### Technique 24

The lens barrel according to Technique 24 is the lens barrel according to any of Techniques 15 to 23,

wherein, in the first state, the restriction on rotation of the focus ring in the manual mode is released.

### Technique 25

The lens barrel according to Technique 25 is the lens barrel according to any of Techniques 15 to 24,

wherein the barrel member is a depth scale ring having a scale index indicating the depth of field when the focus ring is turned.

### Industrial Applicability

The lens barrel of the present disclosure exhibits the effect of giving different displays depending on the imaging mode, and reducing the size of the lens barrel in the optical axis direction when not imaging, and therefore can be broadly applied to lens barrels attached to various kinds of imaging device.

### Reference Signs List

10 lens barrel
11 filter ring
12 index ring
13 aperture ring
13a main body portion
13b encoder brush
13ca click groove
13cb click groove
13d click portion
14 presser ring
14a spring
14b click ball
15 focus ring
15a main body portion
15b encoder brush
15c rectilinear guide groove
15d bayonet
15e click groove
15f click groove
16 distance scale ring (display)
16a main body (display main body portion)
16b normal imaging scale display (first display)
16c macro imaging scale display (second display)
16d protrusion
16e slide groove
17 cam pin frame
17a main body portion (cam pin frame main body portion)
17b protrusion
17c cam pin (third cam pin)
18 movable ring frame (movable frame)
18a main body portion (movable main body portion)
18b cam pin (fourth cam pin)
18ba threaded hole
18c sliding surface
18d through-hole
18e threaded hole
18f through-hole
19a encoder base
19aa spring
19ab click ball
19ba, 19bb encoder
19c connecting flexible cable
19d screw
20 first lens frame (lens frame)
20a main body portion (lens frame main body portion)
20b cam pin (second cam pin)
21 depth scale ring
21a main body portion
21b indicator
21c click groove
21d click groove
21e click groove
21f convex part
22 switching ring

22a main body portion
22b click leaf spring
22ba distal end portion
22bb hole
22bc convex part
22c screw
22d rectilinear groove
23 fixed barrel
23a main body portion (fixed main body portion)
23b cam groove (first cam groove)
23c rectilinear groove (first rectilinear groove)
23d rectilinear groove (second rectilinear groove)
23e flange portion
23f recess
24 cam barrel
24a main body portion (cam main body portion)
24b cam pin (first cam pin)
24c cam groove (second cam groove)
24e cam groove (synchronization cam groove)
24f cam groove (display switching cam groove)
24fa groove portion (first groove portion)
24fb groove portion (interference avoidance groove portion)
24fc groove portion (second groove portion)
25 second lens frame
26 control board
27 rear frame
27a main body portion
27b indicator
28 lens mount
29 contact unit
30 light-shielding frame
110 lens barrel
116 distance scale ring (display unit)
116a main body portion (display main body portion)
116b display panel
210 lens barrel
215 focus ring
215a main body portion
215b escape groove (groove portion)
221 depth scale ring (barrel member)
221a main body portion
221b end surface
221c convex part
230 focus grip unit
231 focus grip
231a housing
231b opening
231c insertion hole
231d press-fit hole
232 slide switch (switching operation part)
232a operation knob
232b bearing portion
233 stopper (restriction unit)
233a bearing portion
233b protrusion
233c through-hole
234 guide shaft
235 spring (biasing member)
236 screw
AX optical axis
L1 first lens group (lens group)
L2 second lens group

What is claimed is:

1. A lens barrel used in a state of having been attached to an imaging device, the lens barrel comprising:
a substantially cylindrical fixed barrel;
a lens group;
a lens frame that holds the lens group, is disposed on an inner diameter side of the fixed barrel, and is configured to be driven in an optical axis direction of the lens group;
a display unit that is disposed at a position at which at least a portion thereof is exposed on an outer peripheral surface, and that is configured to display a first display and a second display different from the first display; and
a switching ring that is rotatably disposed on an outer peripheral side of the fixed barrel and that is configured to switch by a rotation operation between a retracted state in which neither the first display nor the second display is displayed and the lens frame has moved to an opposite side from a subject in the optical axis direction, a normal imaging state in which only the first display is displayed and the lens frame has moved toward a subject side in the optical axis direction, and a macro imaging state in which only the second display is displayed and the lens frame has moved further toward the subject side in the optical axis direction.

2. The lens barrel according to claim 1,
wherein the display unit further has a substantially cylindrical display main body portion disposed on the inner diameter side of the fixed barrel, and
the first display is provided on the outer peripheral surface of the display main body portion, and the second display is provided at a position adjacent to the first display on the display main body portion in the optical axis direction.

3. The lens barrel according to claim 1,
wherein the display unit has a display panel configured to switch between non-display, the first display, and the second display in response to the turning of the switching ring.

4. The lens barrel according to claim 2,
wherein the display unit moves back and forth in the optical axis direction in conjunction with a transition to a retracted state, the normal imaging state, and the macro imaging state, which are switched in response to the turning of the switching ring.

5. The lens barrel according to claim 1,
further comprising a cam barrel having a substantially cylindrical cam body portion and a first cam pin that is provided so as to protrude in a radial direction from the cam body portion,
wherein the fixed barrel further has a first cam groove in which the first cam pin moves in a state of being engaged in a transition from the retracted state to the normal imaging state.

6. The lens barrel according to claim 5,
wherein the lens frame has a substantially cylindrical lens frame main body portion and a second cam pin that is provided so as to protrude in the radial direction from the lens frame main body, and
the cam barrel further has a second cam groove that is provided to the cam main body portion, and in which the second cam pin moves in a state of being engaged in a transition from the normal imaging state to the macro imaging state.

7. The lens barrel according to claim 2,
wherein the lens frame has a substantially cylindrical lens frame main body portion and a second cam pin that is provided so as to protrude in a radial direction from the lens frame main body portion,
there is further provided a cam pin frame having a substantially cylindrical cam pin frame main body portion rotatably provided on an inner peripheral surface side of the substantially cylindrical display main body portion, and a third cam pin provided so as to protrude in the radial direction from the cam pin frame main body portion, and
the fixed barrel has a first rectilinear groove that runs in the optical axis direction and in which the second cam pin and the third cam pin move in a state of being engaged.

8. The lens barrel according to claim 4,
wherein the display unit further has a slide groove provided running linearly along a circumferential direction on a side of the inner peripheral surface of the display main body portion, and
there is further provided a cam pin frame having a substantially cylindrical cam pin frame main body portion rotatably provided on an inner peripheral surface side of the substantially cylindrical display main body portion, and a protrusion portion that is provided so as to protrude outward in a radial direction from the cam pin frame main body portion and moves in the circumferential direction along the slide groove.

9. The lens barrel according to claim 8,
wherein the cam pin frame further has a third cam pin provided so as to protrude in the radial direction from the cam pin frame main body portion, and
there is further provided a cam barrel having a display switching cam groove configured to move the cam pin frame, with which the display unit is integrated in the optical axis direction, back and forth in the optical axis direction when the third cam pin is moved in an engaged state by turning the switching ring.

10. The lens barrel according to claim 9,
wherein the display switching cam groove has a first groove portion that is provided along the circumferential direction and in which the third cam pin of the cam pin frame is positioned in the retracted state, an interference avoidance groove portion configured to guide the third cam pin to the opposite side from the subject when a state is transferred from the retracted state to the normal imaging state and the display unit is moved toward the subject side in the optical axis direction, and a second groove portion configured to guide the third cam pin toward the subject side when a state is transferred from the normal imaging state to the macro imaging state and the display unit is moved further toward the subject side in the optical axis direction.

11. The lens barrel according to claim 1,
further comprising a movable frame having a substantially cylindrical movable main body portion and a fourth cam pin that is provided so as to protrude in a radial direction from the movable main body portion,
wherein the fixed barrel further has a substantially cylindrical fixed main body portion and a second rectilinear groove that is provided along the optical axis direction and in which the fourth cam pin provided to the movable frame moves in a state of being engaged.

12. The lens barrel according to claim 11,
further comprising a cam barrel having a substantially cylindrical cam main body portion and a synchronous cam groove that is provided along a circumferential direction and moves the movable frame synchronously in the optical axis direction when the fourth cam pin moves in a state of being engaged.

13. The lens barrel according to claim 1,
wherein the first display is a scale display including a first distance, an aperture, or a F-number, and is displayed in the normal imaging state.

14. The lens barrel according to claim 1,
wherein the second display is a scale display including a second distance, an aperture, or a F-number, and is displayed in the macro imaging state.

15. A lens barrel used in a state of being attached to an imaging device, comprising:
a substantially cylindrical fixed barrel;
a lens group;
a lens frame that holds the lens group, is disposed on an inner diameter side of the fixed barrel, and is driven in an optical axis direction of the lens group;
a focus ring that is provided on an outer peripheral side of the fixed barrel and is configured to be rotated around the optical axis of the lens group relative to the fixed barrel when the focus is adjusted manually;
a substantially cylindrical barrel member that is provided on the outer peripheral side of the fixed barrel; and
a rotation restriction switching unit that is fixed on the outer peripheral side of the focus ring, and is configured to switch between a first state in which contact with a part of the barrel member prevents switching between an automatic mode that automatically performs focus adjustment of the focus ring and a manual mode that performs the focus adjustment manually, and a second state in which the contact with a part of the barrel member is released, allowing switching of the focus ring between the automatic mode and the manual mode, and has a restriction unit configured to disable switching between the automatic mode and the manual mode in a retracted state in which the lens frame has moved to an opposite side from a subject in the optical axis direction.

16. The lens barrel according to claim 15,
wherein the barrel member has an end surface that intersects the optical axis direction, and a convex part that protrudes from the end surface in the optical axis direction, and
the restriction unit, in the first state, comes into contact with the convex part in a rotational direction to restrict rotation of the focus ring, and in the second state, the contact with the convex part in the rotational direction is released, allowing the focus ring to rotate.

17. The lens barrel according to claim 16,
wherein the rotation restriction switching unit further has a biasing member configured to bias the restriction unit toward a position of coming into contact with the convex part, and a switching operation unit configured to be operated so as to move the restriction unit in a direction opposite from a direction in which the restriction unit makes contact with the convex part in a transition from the first state to the second state.

18. The lens barrel according to claim 17,
wherein in the first state, the restriction unit does not make contact with the end surface of the barrel member in the optical axis direction, and instead makes contact with a part of the switching operation unit.

19. The lens barrel according to claim 17,
wherein in the retracted state, the restriction unit makes contact with the end surface of the barrel member and does not make contact with a part of the switching operation unit.

20. The lens barrel according to claim 17,
wherein the biasing member biases the restriction unit in the optical axis direction.

21. The lens barrel according to claim 17,
wherein the rotation restriction switching unit further has a guide shaft that is disposed along the optical axis direction, and
the switching operation unit is operated so as to slide along the guide shaft in the optical axis direction.

22. The lens barrel according to claim 16,
wherein the focus ring has a groove portion that, in the retracted state, accommodates the convex part of the barrel member on an inner peripheral surface side.

23. The lens barrel according to claim 16,
wherein, in the retracted state, the restriction unit makes contact with the end surface of the barrel member, making it impossible to switch between the automatic mode and the manual mode.

24. The lens barrel according to claim 15,
wherein, in the first state, the restriction on rotation of the focus ring in the manual mode is released.

25. The lens barrel according to claim 15,
wherein the barrel member is a depth scale ring having a scale index indicating a depth of field when the focus ring is turned.
